(19) United States
(12) Patent Application Publication
(10) Pub. No.: US 2024/0396448 A1
(43) Pub. Date: Nov. 28, 2024

(54) SWITCHING POWER CONVERTERS INCLUDING INJECTION STAGES, AND ASSOCIATED METHODS

(71) Applicant: Maxim Integrated Products, Inc., San Jose, CA (US)

(72) Inventor: Alexandr Ikriannikov, San Jose, CA (US)

(21) Appl. No.: 18/793,778

(22) Filed: Aug. 3, 2024

Related U.S. Application Data
(63) Continuation-in-part of application No. 17/658,165, filed on Apr. 6, 2022, now Pat. No. 12,057,767.
(60) Provisional application No. 63/187,828, filed on May 12, 2021.

(51) Int. Cl. H02M 3/155; H02M 1/08

(52) U.S. Cl. CPC H02M 3/155; H02M 1/08

(57) ABSTRACT

A switching power converter includes (i) a plurality of power stages including respective power transfer windings, (ii) an injection stage including a plurality of injection windings electrically coupled in series, (iii) a magnetic core, and (iv) a controller. The magnetic core includes a plurality of power transfer rungs and a plurality of injection rungs disposed between a first rail and a second rail in a first direction. Each power transfer winding is wound around a respective one of the plurality of power transfer rungs, and each injection winding is wound around a respective one of the plurality of injection rungs. The controller is configured to (i) control duty cycle of the power stages to regulate at least one parameter of the switching power converter and (ii) control the injection stage to reduce voltage across a respective leakage inductance of each power transfer winding.

### RELATED APPLICATIONS

This application is a continuation-in-part of U.S. patent application Ser. No. 17/658,165, filed on Apr. 6, 2022, which claims benefit of U.S. Provisional Patent Application Ser. No. 63/187,828, filed on May 12, 2021. Each of the aforementioned patent applications is incorporated herein by reference.

### BACKGROUND

Inductors are commonly used for energy storage in switching power converters. Some switching converters include one or more discrete inductors, where a discrete inductor is an inductor that is not magnetically coupled to any other inductor. Other switching power converters include one or more coupled inductors, where a coupled inductor is a device including two or more inductors that are magnetically coupled. A coupled inductor exhibits magnetizing inductance, which is inductance associated with magnetic flux linking all windings of the coupled inductor. Additionally, each winding of a coupled inductor exhibits leakage inductance, which is inductance associated with magnetic flux that links only the winding, i.e., magnetic flux that does not couple to any other winding. As known in the art, use of a coupled inductor in place of two or more discrete inductors in a switching power converter can achieve significant advantages, such as reduced ripple current magnitude and/or improved transient response.

### BRIEF DESCRIPTION OF THE DRAWINGS

FIG. 1 is a graph of normalized ripple current magnitude versus duty cycle for five different switching power converters.

FIG. 2 is a schematic diagram of a multi-phase switching power converter including an injection stage, according to an embodiment.

FIG. 3 is a schematic diagram one possible implementation of switching stages of the FIG. 2 switching power converter.

FIG. 4 is an electrical model of a coupled inductor of the FIG. 2 switching power converter.

FIGS. 5A-5D are graphs illustrating one example of operation of an embodiment of the FIG. 2 switching power converter including two power stages.

FIGS. 6A-6F are graphs illustrating one example of operation of an embodiment of the FIG. 2 switching power converter including four power stages.

FIG. 7 is a schematic diagram of an alternate embodiment of the FIG. 2 switching power converter which includes an injection stage configured to compensate for a power transfer winding being driven high.

FIGS. 8A-8D are graphs illustrating one example of operation of an embodiment of the FIG. 7 switching power converter including two power stages.

FIG. 9 is a schematic diagram of an alternate embodiment of the FIG. 2 switching power converter including an asymmetric coupled inductor.

FIG. 10A-10D are graphs illustrating one example of operation of an embodiment of the FIG. 9 switching power converter including two power stages.

FIG. 11 is a schematic diagram of an alternate embodiment of the FIG. 2 switching power converter including two power sub-converters.

FIGS. 12A-12D are graphs illustrating one example of operation of an embodiment of the FIG. 11 switching power converter.

FIG. 13 is a schematic diagram of an alternate embodiment of the FIG. 2 switching power converter having a multi-phase boost-type topology.

FIGS. 14A-14D are graphs illustrating one example of operation of an embodiment of the FIG. 13 switching power converter.

FIG. 15 is a schematic diagram of an alternate embodiment of the FIG. 2 switching power converter having a multi-phase buck-boost-type topology.

FIGS. 16A-16D are graphs illustrating one example of operation of an embodiment of the FIG. 15 switching power converter.

FIG. 17 is a schematic diagram of an alternate embodiment of the FIG. 2 switching power converter having only one phase.

FIGS. 18A-18C are graphs illustrating one example of operation of an embodiment of the FIG. 17 switching power converter.

FIG. 19 is a block diagram of an example application of the switching power converters disclosed herein.

FIG. 20 is a graph illustrating an example of operation of an embodiment of the FIG. 2 switching power converter with an injection stage disabled.

FIG. 21 is a graph illustrating an example of operation of the same embodiment considered in FIG. 20 but with the injection stage enabled.

FIG. 22 is a graph illustrating an example of operation of another embodiment of the FIG. 2 switching power converter with an injection stage disabled.

FIG. 23 is a graph illustrating an example of operation of the same embodiment considered in FIG. 22 but with the injection stage enabled.

FIG. 24 is a graph illustrating an example of operation of an embodiment of the FIG. 17 switching power converter with an injection stage disabled.

FIG. 25 is a graph illustrating an example of operation of the same embodiment considered in FIG. 24 but with the injection stage enabled.

FIG. 26 is a plan view of a magnetic core.

FIG. 27 is a plan view of the FIG. 26 magnetic core illustrating one example of magnetic flux flowing through the magnetic core.

FIG. 28 is a plan view of the FIG. 26 magnetic core illustrating another example of magnetic flux flowing through the magnetic core.

FIG. 29 is a plan view of an asymmetric magnetic core, according to an embodiment.

FIG. 30 is a cross-sectional view of the FIG. 29 magnetic core.

FIG. 31 is a plan view of a coupled inductor including an instance of the FIG. 29 magnetic core, according to an embodiment.

FIG. 32 is a cross-sectional view of the FIG. 31 coupled inductor.

FIG. 33 is a top plan view of a magnetic core that enables use of power transfer windings and injections windings having a common configuration, according to an embodiment.

FIG. 34 is a cross-sectional view of the FIG. 33 magnetic core taken along line 34A-34A of FIG. 33.

FIG. 35 is a left side elevational view of the FIG. 33 magnetic core.

FIG. 36 is a right side elevational view of the FIG. 33 magnetic core.

FIG. 38 is a top plan view of a coupled inductor including the FIG. 33 magnetic core, according to an embodiment.

FIG. 39 is a cross-sectional view of the FIG. 38 coupled inductor taken along line 39A-39A of FIG. 38.

FIG. 40 is a schematic diagram of an embodiment of the FIG. 2 multi-phase switching power converter including the FIG. 38 coupled inductor.

FIG. 41 is a top plan view of the FIG. 39 magnetic core that is marked-up to symbolically show leakage magnetic flux in the magnetic core.

FIG. 42 is a top plan view of an alternate embodiment of the FIG. 33 magnetic core including an additional power transfer rung and an additional injection rung.

FIG. 43 is a top plan view of an alternate embodiment of the FIG. 38 coupled inductor including the FIG. 42 magnetic core in place of the FIG. 33 magnetic core.

FIG. 44 is a top plan view of an alternate embodiment of the FIG. 33 magnetic core including only two power transfer rungs and only one injection rung.

FIG. 45 is a top plan view of an alternate embodiment of the FIG. 38 coupled inductor including the FIG. 44 magnetic core in place of the FIG. 33 magnetic core.

FIG. 46 is a top plan view of an alternate embodiment of the FIG. 38 coupled inductor including a single injection winding.

FIG. 47 is a cross-sectional view of the FIG. 46 coupled inductor taken along line 47A-47A of FIG. 46.

FIG. 48 is a cross-sectional view of the FIG. 46 coupled inductor taken along line 48A-48A of FIG. 46.

FIG. 49 is a perspective view of the injection winding of the FIG. 46 coupled inductor.

FIG. 50 is a schematic diagram of an embodiment of the FIG. 2 multi-phase switching power converter including the FIG. 46 coupled inductor.

FIG. 51 is a top plan view of an alternate embodiment of the FIG. 46 coupled inductor including a plurality of injection windings in place of the single injection winding.

FIG. 52 is a cross-sectional view of the FIG. 51 coupled inductor taken along line 52A-52A of FIG. 51.

FIG. 53 FIG. 53 is a cross-sectional view of the FIG. 51 coupled inductor taken along line 53A-53A of FIG. 51.

FIG. 54 is a top plan view of an instance of the injection windings of the FIG. 51 coupled inductor.

FIG. 55 is a perspective view of an instance of the injection windings of the FIG. 51 coupled inductor.

FIG. 56 is a schematic diagram of an embodiment of the FIG. 2 multi-phase switching power converter including the FIG. 51 coupled inductor.

FIG. 57 is a schematic diagram of an alternate embodiment of the FIG. 2 multi-phase switching power converter further including a second coupled inductor.

### DETAILED DESCRIPTION OF THE EMBODIMENTS

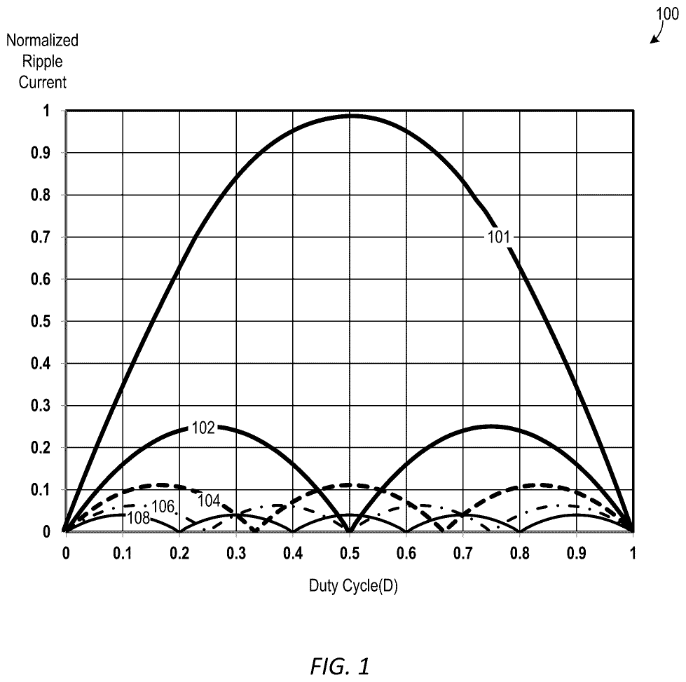

A multiphase switching power converter including a coupled inductor can operate in a manner which minimizes, or even essentially eliminates, ripple current magnitude. For example, FIG. 1 is a graph 100 of normalized ripple current magnitude in one phase versus duty cycle for five switching power converters. Curve 101 corresponds to a single-phase switching power converter, curve 102 corresponds to a two-phase switching power converter, curve 104 corresponds to a three-phase switching power converter, curve 106 corresponds to a four-phase switching power converter, and curve 108 corresponds to a five-phase switching power converter. The single-phase switching power converter includes a discrete inductor. Each of the multi-phase switching power converters includes a coupled inductor with leakage inductance values equal to an inductance value of the discrete inductor of the single-phase switching power converter. Ripple current magnitude is normalized relative to a maximum ripple current magnitude of the single-phase switching power converter (which occurs at a duty cycle of 0.5). Graph 100 assumes that the coupled inductor of each multi-phase switching power converter has essentially ideal magnetic coupling, i.e., magnetizing inductance is many times greater than leakage inductance of any one winding. All switching power converters of the FIG. 1 graph are assumed to operate at a common switching frequency.

As evident from FIG. 1, each switching power converter has one or more operating points where ripple current magnitude is essentially zero. For example, ripple current magnitude in the two-phase switching power converter is essentially zero when operating at 50 percent duty cycle, and ripple current magnitude in the three-phase switching power converter is essentially zero when operating at either 33 percent duty cycle or 66 percent duty cycle. However, each switching power converter also has operating points where ripple current magnitude is large, especially if the number of phases is small. For example, the two-phase switching power converter will have large ripple current magnitude when duty cycle is approximately either 25 percent or 75 percent, and the switching power converter with discrete inductors will have a large ripple current magnitude except when operating around zero duty cycle or around one hundred percent duty cycle.

Disclosed herein are switching power converters including injection stages which at least partially overcome the above-discussed drawbacks of conventional switching power converters. For example, certain embodiments of the new switching power converters have small ripple current magnitude at essentially any duty cycle, instead of at only certain duty cycles. Consequently, the new switching power converters may incur smaller losses than otherwise similar conventional switching power converters, due to their ability to operate at low ripple current magnitude over a wide range of duty cycles. Additionally, the low ripple current magnitude of the new switching power converters promotes low ripple voltage magnitude, thereby potentially enabling relaxed filtering requirements relative to conventional switching power converters. Furthermore, in particular embodiments, ripple current magnitude is determined by magnetizing inductance instead of by leakage inductances. Consequently, magnetizing inductance can be made large to minimize ripple current magnitude, without negatively impacting transient response, because magnetizing inductance does not impair transient response. In a conventional switching power converter, in contrast, ripple current magnitude is determined primarily by leakage inductance (or by discrete inductance if the converter does not include a coupled inductor). Ripple current magnitude can be decreased in a conventional switching power converter by increasing leakage/discrete inductance, but doing so degrades transient response.

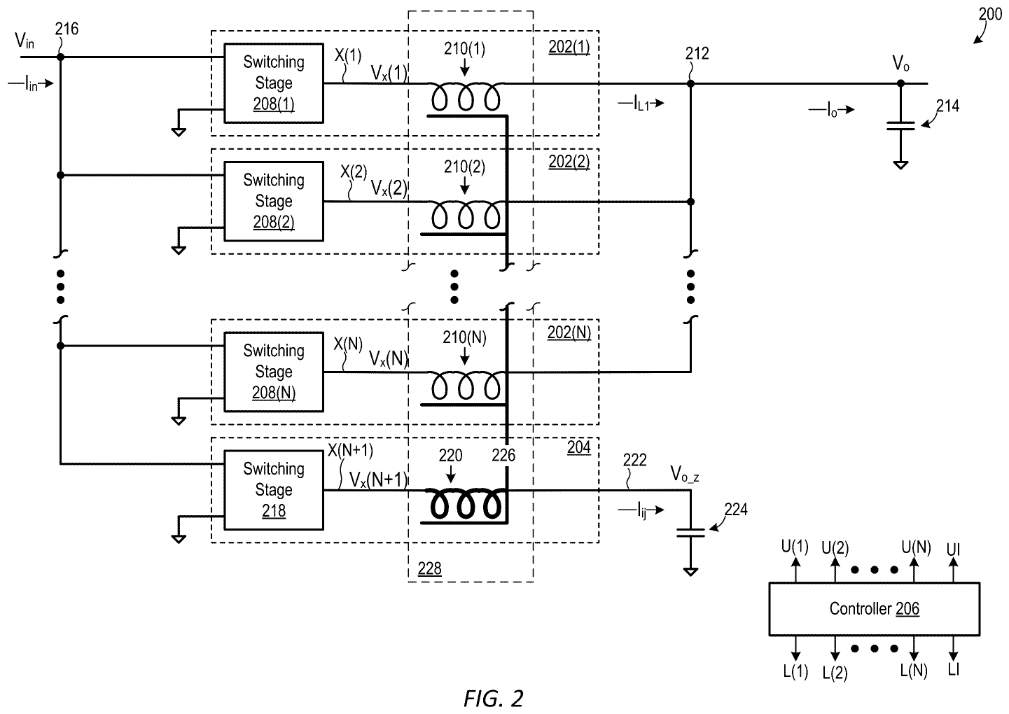

FIG. 2 is a schematic diagram of a multi-phase switching power converter 200, which is one embodiment of the new switching power converters disclosed herein. Switching power converter 200 includes N power stages 202, an injection stage 204, and a controller 206, where N is an integer greater than one. In this document, specific instances of an item may be referred to by use of a numeral in parentheses (e.g., power stage 202(1)) while numerals without parentheses refer to any such item (e.g., power stages 202). Each power stage 202 corresponds to a respective phase of switching power converter 200, such that switching power converter 200 is an N-phase switching power converter.

Each power stage 202 includes a power switching stage 208 electrically coupled to a power transfer winding 210 at a switching node X. Each power transfer winding 210 is electrically coupled between the switching node X of its respective power stage 202 and a common output node 212. For example, power transfer winding 210(1) is electrically coupled between switching node X(1) and output node 212, and power transfer winding 210(2) is electrically coupled between switching node X(2) and output node 212. Output node 212 has a voltage Vₒ, and an output current Iₒ flows to a load (not shown) electrically coupled to output node 212. Output current Iₒ could have a negative polarity without departing from the scope hereof. One or more capacitors 214 are optionally electrically coupled to output node 212.

Each power switching stage 208 is configured to repeatedly switch the switching node X of its power stage 202 between an input power node 216 and ground, in response to control signals U and L generated by controller 206. Specifically, power switching stage 208(1) is configured to repeatedly switch node X(1) between input power node 216 and ground in response to control signals U(1) and L(1), power switching stage 208(2) is configured to repeatedly switch node X(2) between input power node 216 and ground in response to control signals U(2) and L(2), and so on. Input power node 216 is at a voltage Vᵢₙ, and each power switching stage 208 accordingly repeatedly switches node X of its power stage 202 between voltage Vᵢₙ and zero volts relative to ground. An input current Iᵢₙ flows from an electrical power source (not shown) to switching power converter 200 via input power node 216. Input current Iᵢₙ could have a negative polarity without departing from the scope hereof. A given power transfer winding 210 in converter 200 is driven “high” when its respective switching node X is at voltage Vᵢₙ, and the power transfer winding 210 is driven “low” when its respective switching node X is at zero volts relative to ground. For example, power transfer winding 210(1) is driven high when switching node X(1) is at voltage Vᵢₙ, and power transfer winding 210(1) is driven low when switching node X(1) is at zero volts relative to ground.

Injection stage 204 includes an injection switching stage 218 electrically coupled to an injection winding 220 at a switching node X(N+1). Injection winding 220 is electrically coupled between switching node X(N+1) and injection output node 222. Injection output node 222, which is separate from output power node 212, is at a voltage V_{o_z}, and one or more capacitors 224 are electrically coupled to injection output node 222. Injection switching stage 218 is configured to repeatedly switch node X(N+1) between input power node 216 and ground in response to control signals UI and LI. Similar to power transfer windings 210, injection winding 220 is driven high when switching node X(N+1) is at voltage Vᵢₙ, and injection winding 220 is driven low when switching node X(N+1) is at zero volts relative to ground. Injection stage 204 does not handle a direct current (DC) component of output current Iₒ. Instead, controller 206 controls injection stage 204 to reduce, or even essentially eliminate, alternating current (AC) voltage across leakage inductances of power transfer windings 210, as discussed below.

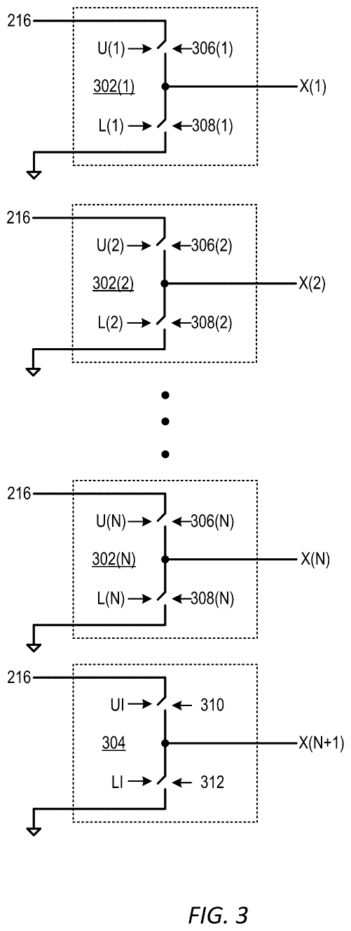

FIG. 3 illustrates one possible implementation of the switching stages of switching power converter 200. Specifically, FIG. 3 is a schematic diagram of N power switching stages 302 and an injection switching stage 304, where (a) power switching stages 302 are an embodiment of power switching stages 208 and (b) injection switching stage 304 is an embodiment of injection switching stage 218. Each power switching stage 302 includes an upper switching device 306 and a lower switching device 308. Each upper switching device 306 is electrically coupled between input power node 216 and the switching node X of its respective power stage. Each lower switching device 308 is electrically coupled between the switching node X of its respective power stage and ground. For example, upper switching device 306(1) is electrically coupled between input power node 216 and switching node X(1), and lower switching device 308(1) is electrically coupled between switching node (X1) and ground. Each upper switching device 306 switches in response to a respective control signal U from controller 206, and each lower switching device 308 switches in response to a respective control signal L from controller 206. For example, in some embodiments, each upper switching device 306 operates in its on (conductive) state when its respective control signal U is asserted, and the switching device operates in its off (non-conductive state) when its respective control signal U is de-asserted. Similarly, in some embodiments, each lower switching device 308 operates in its on (conductive) state when its respective control signal L is asserted, and the switching device operates in its off (non-conductive state) when its respective control signal L is de-asserted. Each switching device 306 and 308 includes, for example, one or more transistors.

Injection switching stage 304 includes an upper switching device 310 and a lower switching device 312. Upper switching device 310 is electrically coupled between input power node 216 and switching node X(N+1), and lower switching device 312 is electrically coupled between switching node X(N+1) and ground. Upper switching device 310 switches in response to control signal UI from controller 206, and lower switching device 312 switches in response to control signal LI from controller 206. For example, in certain embodiments, upper switching device 310 operates in its on (conductive) state when control signal UI is asserted, and the switching device operates in its off (non-conductive state) when its control signal UI is de-asserted. Similarly, in some embodiments, lower switching device 312 operates in its on (conductive) state when control signal LI is asserted, and the switching device operates in its off (non-conductive state) when control signal LI is de-asserted. Each switching device 310 and 312 includes, for example, one or more transistors. In some embodiments, upper switching device 310 has a smaller current carrying capability than each upper switching device 306, and lower switching device 312 has a smaller current carrying capability than each lower switching device 308, due to injection stage 204 not needing to handle the DC component of output current Iₒ.

Referring again to FIG. 2, power transfer windings 210 are magnetically coupled by a magnetic core 226, and injection winding 220 is magnetically coupled to each power transfer winding 210 by magnetic core 226. Power transfer windings 210, injection winding 220, and magnetic core 226 are part of a coupled inductor 228. Magnetic core 226 is formed, for example, of a ferrite magnetic material or an iron powder magnetic material. However, magnetic core 226 could alternately be an “air core,” or in other words, magnetic core 226 could be implemented by placing windings 210 and 220, or breaking these windings in sections and placing these sections in pairs in sufficient proximity, to achieve magnetic coupling without use of a tangible magnetic coupling structure. Injection winding 220 is drawn with a heavier line weight than power transfer windings 210 to help a viewer distinguish injection winding 220 from power transfer windings 210. This difference in line weight should not be construed to imply that the configuration of injection winding 220 necessarily differs from the configuration of power transfer windings 210. The injection winding could actually be implemented with a smaller amount of conductor material because it has only AC ripple and does not carry any load current.

Controller 206 is implemented, for example, by analog and/or electronic circuitry. In some embodiments, controller 206 is at least partially implemented by a processor (not shown) executing instructions in the form of software and/or firmware stored in a memory (not shown). Although controller 206 is depicted as a discrete element for illustrative simplicity, controller 206 could be partially or fully integrated with one or more other elements of switching power converter 200. For example, some subsystems of controller 206 could be incorporated in one or more of power switching stages 208 and/or injection switching stage 218. Additionally, FIG. 2 should not be construed to require that there be a separate control bus for each control signal. For example, controller 206 could be implemented by a combination of a central integrated circuit and local control logic integrated in each switching stage 208 and 218, with a single control bus running from the central integrated circuit to each switching stage 208 and 218. Furthermore, controller 206 could be configured to derive control signal UI and LI from one or more of control signals U and L, such as by using logic circuitry, instead of by independently generating control signals UI and LI. Moreover, controller 206 may include multiple constituent elements that need not be co-packaged over even disposed at a common location.

Controller 206 is configured to generate control signals U and L to control duty cycle (D) of power stages 202, where duty cycle is a portion of a switching cycle that a power transfer winding 210 is driven high, to regulate at least one parameter of switching power converter 200. Examples of possible regulated parameters include, but are not limited, magnitude of input voltage Vᵢₙ, magnitude of input current Iᵢₙ, magnitude of output voltage Vₒ, and magnitude of output current Iₒ. For example, in some embodiments, controller 206 is configured to generate control signals U and L to regulate magnitude of output voltage Vₒ, and controller 206 accordingly generates control signals U and L during continuous conduction operation of switching power converter 200 such that duty cycle of power stages 202 is equal to a ratio of output voltage magnitude Vₒ over input voltage magnitude Vᵢₙ. For example, if output voltage Vₒ is to be regulated to two volts and input voltage Vᵢₙ is eight volts, controller 206 would generate control signals U and L such that duty cycle of power stages 202 is 0.25. Controller 206 is optionally configured to generate control signals U and L such that power stages 202 switch out-of-phase with each other. For example, in some embodiments, controller 206 is configured to generate control signals U and L such that each power stage 202 switches 360/N degrees out of phase with an adjacent power stage 202 in the phase domain.

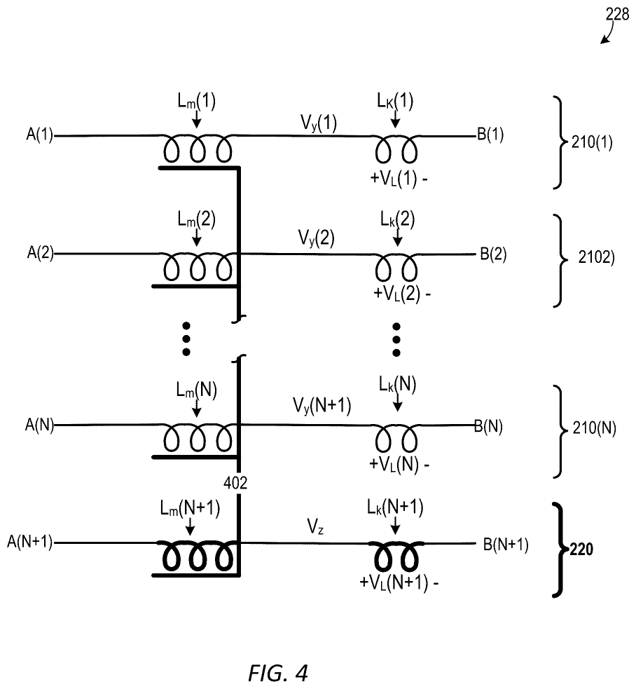

Controller 206 is further configured to generate control signals UI and LI to control injection stage 204 such that the injection stage injects magnetic flux in magnetic core 226 in a manner which reduces voltage across a respective leakage inductance of each power transfer winding 210. Such reduction in voltage across leakage inductances advantageously reduces, or even essentially eliminates, magnitude of ripple current associated with charging and discharging of leakage inductances. To help appreciate this feature, refer to FIG. 4, which is an electrical model of coupled inductor 228. Each power transfer winding 210 exhibits a respective magnetizing inductance Lₘ and a respective leakage inductance Lₖ. Similarly, injection winding 220 exhibits a magnetizing inductance Lₘ(N+1) and a leakage inductance Lₘ(N+1). Magnetizing inductances Lₘ collectively form an ideal transformer with magnetic coupling symbolically shown by a magnetic core 402. When coupled inductor 228 is connected as shown in FIG. 2, each terminal A(1)-A(N+1) is electrically coupled to a respective switching node X, each terminal B(1)-B(N) is electrically coupled to output node 212, and terminal B(N+1) is electrically coupled to injection output node 222. However, coupled inductor 228 could be connected in other manners without departing from the scope hereof.

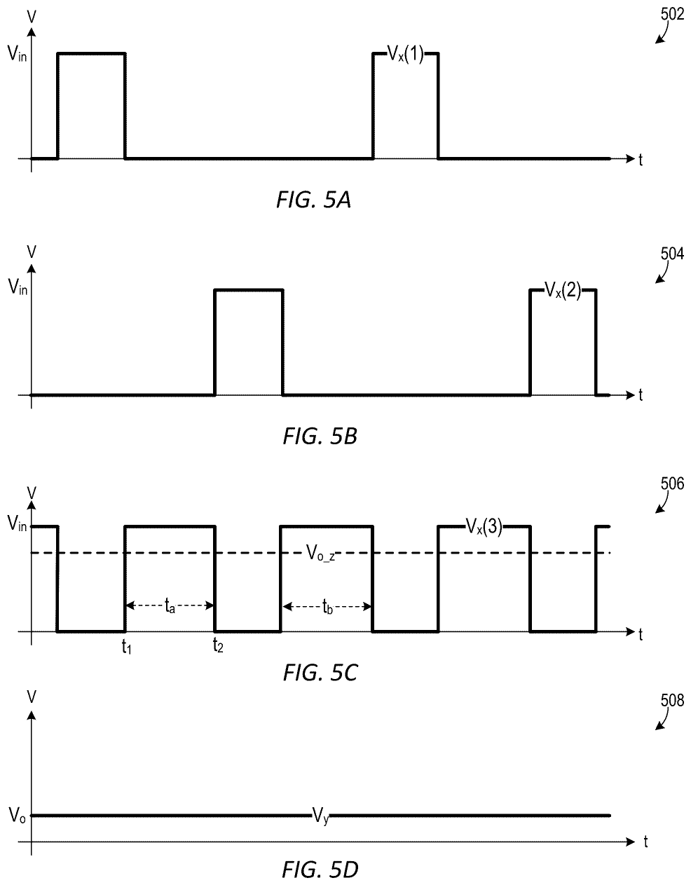

Ripple current associated with leakage inductances Lₖ results from respective AC voltages V_{L} across the leakage inductances. Accordingly, controller 206 is configured to generate control signals UI and LI to operate injection stage 204 in a manner that reduces voltages V_{L} across leakage inductances, to reduce ripple current magnitude. For example, FIGS. 5A-5D are graphs collectively illustrating one example of operating of an embodiment of switching power converter 200 where N is equal to two, such that switching power converter 200 includes two power stages 202 and one injection stage 204. Graphs 5A-5D also assume that the magnetizing inductance value of coupled inductor 228 is much greater than any leakage inductance value of coupled inductor 228. Graph 502 is a graph of switching node voltage Vₓ(1) versus time, and graph 504 is a graph of switching node voltage Vₓ(2) versus time. As illustrated in FIGS. 5A and 5B, each switching node X(1) and X(2) is repeatedly driven high and low between Vᵢₙ and zero volts, respectively, and the switching nodes are driven high and low out-of-phase with each other. FIG. 5C is a graph 506 including a curve representing voltage at the injection switching node X(N+1), which is node X(3) because N is equal to two in this example. FIG. 5C also includes a curve representing voltage V_{o_z} at injection output node 222. FIG. 5D is a graph 508 of intermediate voltages V_{y} between magnetizing inductances Lₘ and leakage inductances Lₖ (see FIG. 4 for intermediate voltages V_{y}). Each intermediate voltage V_{y} has essentially constant value due to the magnetizing inductance value of coupled inductor 228 being very large relative to the leakage inductance values.

In the example of FIGS. 5A-5D, controller 206 controls injection stage 204 so that injection stage 204 switches in a manner which compensates for power transfer windings 210 being driven low. Specifically, injection winding 220 is driven high in response to any power transfer winding 210 being driven low, and injection winding 220 is driven low in response to any power transfer winding 210 being driven high, as illustrated in FIGS. 5A-5C. For example, injection winding 220 is driven high at time t₁ in response to power transfer winding 210(1) being driven low, and injection winding 220 is driven low at time t₂ in response to power transfer winding 210(2) being driven high. Consequently, intermediate voltages V_{y} remain essentially constant at the value of Vₒ, as shown in FIG. 5D. As a result, voltages on both sides of each leakage inductance Lₖ are essentially identical, i.e., voltage at each side of each leakage inductance Lₖ is essentially equal to Vₒ. For example, referring to FIG. 4, voltage V_{y}(1) is essentially equal to Vₒ, and voltage at terminal B(1) is also equal Vₒ. Therefore, voltages V_{L} across leakage inductances Lₖ remain essentially at zero even as power transfer windings 210 are repeatedly driven between high and low states to regulate one or more parameters of switching power converter 200. As a result, there is no material ripple current associated with leakage inductances Lₖ, irrespective of operating duty cycle of switching power converter 200.

It should be noted that there will be ripple current associated with charge and discharge of magnetizing inductance Lₘ. However, such ripple current magnitude will be small if magnetizing inductance Lₘ is large. Additionally, as discussed above, increasing magnetizing inductance Lₘ does not degrade transient response. In a conventional switching power converter with a coupled inductor, in contrast, ripple current magnitude can be decreased mainly by increasing leakage inductance values and/or switching frequency, both of which have drawbacks. Specifically, increasing leakage inductance values impairs transient response, and increasing switching frequency increases switching power loss. Ripple current magnitude in a conventional coupled inductor can also be decreased by increasing magnetizing inductance Lₘ, but improvement will be limited and soon achieve diminishing returns. Accordingly, switching power converter 200 can achieve low ripple current magnitude without the drawbacks of achieving low ripple current magnitude in a conventional switching power converter.

The example of FIGS. 5A-5D assumes essentially ideal magnetic coupling of the windings of coupled inductor 228, i.e., that the magnetizing inductance value is much greater than any leakage inductance value. Such assumption may not hold true in practical implementations, and voltages V_{L} will therefore not necessarily be zero in practical implementations. Nevertheless, injection stage 204 may significantly reduce voltages V_{L}, such that injection stage 204 may significantly reduce ripple current magnitude, even if non-ideal coupling of coupled inductor 228 prevents injection stage 204 from completely eliminating ripple current associated with leakage inductances Lₖ. Additionally, FIGS. 5A-5D assume ideal timing, i.e., that injection stage 204 switches in synchronicity with power stages 202. While such synchronicity may be desired, it is not required for acceptable operation of switching power converter 200.

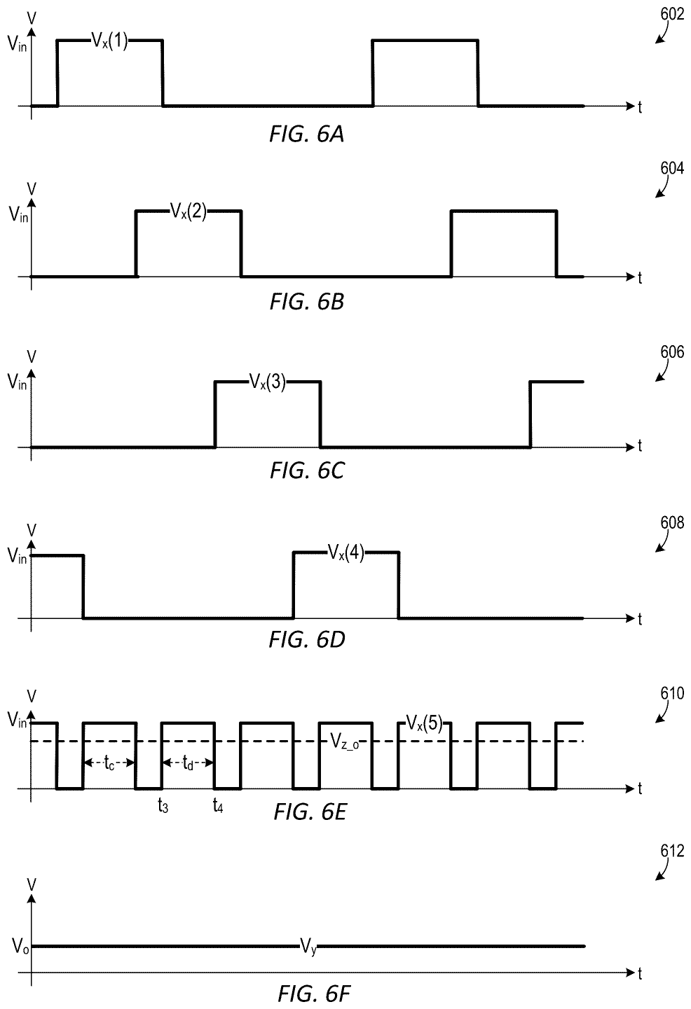

The example of FIGS. 5A-5D assumes that power stages 202 are driven high in a non-overlapping manner, or in other words, that no more than one power stage 202 is driven high at any given time. However, switching power converter 200 is not limited to non-overlapping operation. For example, FIGS. 6A-6F are graphs collectively illustrating one example of operation of an embodiment of switching power converter 200 where N is equal to four, such that switching power converter 200 includes four power stages 202 and one injection stage 204. Graphs 6A-6F also assume that the magnetizing inductance value of coupled inductor 228 is much greater than any leakage inductance value of coupled inductor 228. Graph 602 is a graph of switching node voltage Vₓ(1) versus time, graph 604 is a graph of switching node voltage Vₓ(2) versus time, graph 606 is a graph of switching node voltage Vₓ(3) versus time, and graph 608 is a graph of switching node voltage Vₓ(4) versus time. As illustrated in FIGS. 6A-6D, each switching node X(1), X(2), X(3), and X(4) is repeatedly driven high and low between Vᵢₙ and zero volts, and the switching nodes are driven high and low out-of-phase with each other. FIG. 6E is a graph 610 including a curve representing voltage at the injection switching node X(N+1), which is node X(5) because N is equal to four in this example. FIG. 6E also includes a curve representing voltage V_{o_z} at injection output node 222. FIG. 6F is a graph 612 of intermediate voltages V_{y} between magnetizing inductances Lₘ and leakage inductances Lₖ. Each intermediate voltage V_{y} has essentially a constant value due to the magnetizing inductance value of coupled inductor 228 being very large relative to the leakage inductance values.

As evident from FIGS. 6A and 6D, the switching node X(1)-X(4) voltages overlap in that two switching nodes may be driven high at the same time. Accordingly, controller 206 controls injection stage 204 so that injection stage 204 switches in a manner which compensates for one power transfer winding 210 being driven low while another power transfer winding 210 is driven high, thereby preventing change in intermediate node voltages V_{y}. For example, injection winding 220 is driven high at time t₃ in response to power transfer winding 210(1) being driven low while power transfer winding 210(2) is driven high, and injection winding 220 is driven low at time t₄ in response to power transfer winding 210(3) being driven high. Accordingly, injection winding 220 is driven high whenever only one power transfer winding 210 is driven high, and injection winding 220 is driven low whenever two power transfer windings 210 are driven high. Consequently, intermediate voltages V_{y} remain essentially constant at the value of Vₒ, as shown in FIG. 6F. Therefore, voltages V_{L} across leakage inductances Lₖ remain essentially at zero even as power transfer windings 210 are repeatedly driven been high and low states to regulate one or more parameters of switching power converter 200. As a result, there is no material ripple current associated with leakage inductances Lₖ, irrespective of operating duty cycle of switching power converter 200.

Similar to the example of FIGS. 5A-5D, the example of FIGS. 6A-6F assumes essentially ideal magnetic coupling of the windings of coupled inductor 228. However, injection stage 204 may significantly reduce ripple current magnitude even if non-ideal coupling of coupled inductor 228 prevents injection stage 204 from completely eliminating ripple current associated with leakage inductances Lₖ. Additionally, while FIGS. 6A-6F assume ideal timing, i.e., that injection stage 204 switches in synchronicity with power stages 202, timing may vary while still achieving acceptable operation of switching power converter 200.

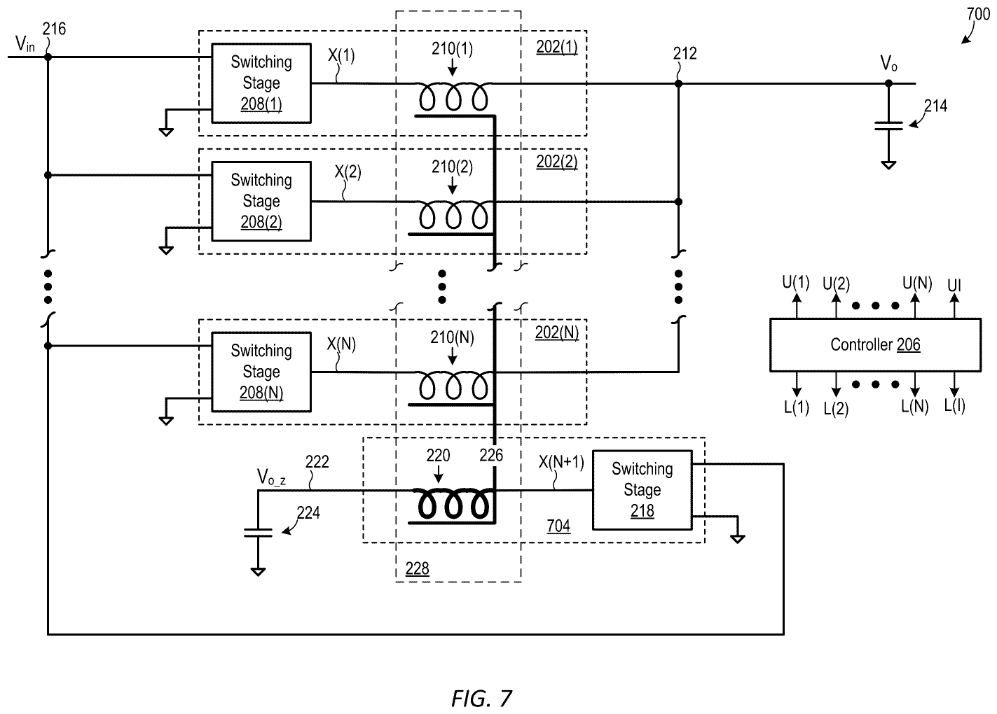

Referring again to FIG. 2, injection stage 204 is configured to compensate for a power transfer winding 210 being driven low, i.e., to inject magnetic flux into magnetic core 226 in a manner which prevents intermediate voltages V_{y} from changing when a power transfer winding 210 is driven low. However, injection stage 204 could be modified to instead compensate for a power transfer winding 210 being driven high, i.e., to inject magnetic flux into magnetic core 226 in a manner which prevents intermediate voltages V_{y} from changing when a power transfer winding 210 is driven high. For example, FIG. 7 is a schematic diagram of a switching power converter 700, which is an alternate embodiment of switching power converter 200 with injection stage 204 replaced with an injection stage 704. Injection stage 704 includes the same constituent elements as injection stage 204, but injection stage 704 is configured to compensate for a power transfer winding 210 being driven high, to prevent intermediate voltages V_{y} from changing when a power transfer winding 210 is driven high.

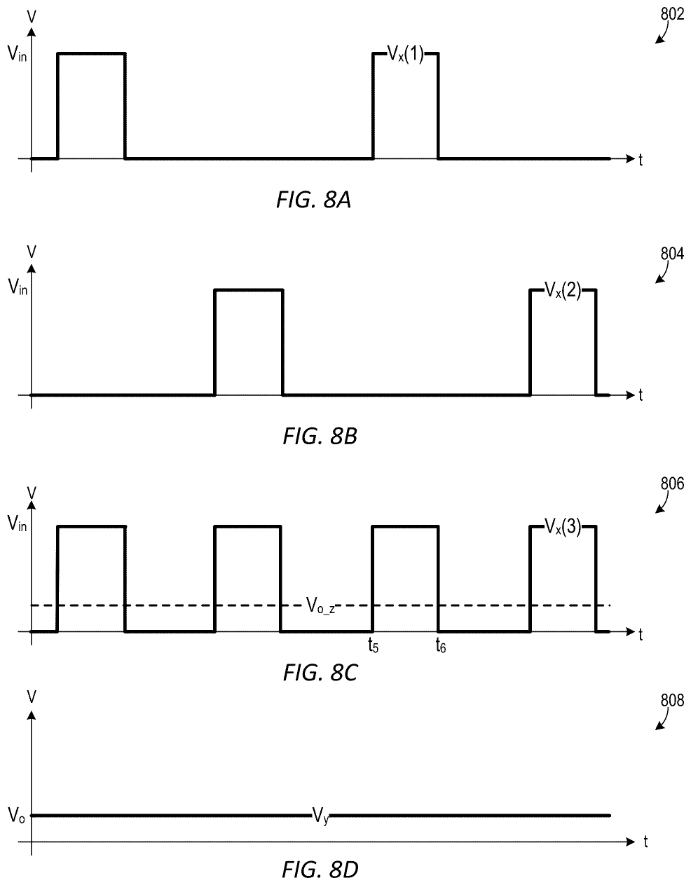

FIGS. 8A-8D are graphs collectively illustrating one example of operation of an embodiment of switching power converter 700 where N is equal to two, such that switching power converter 700 includes two power stages 202 and one injection stage 204. Graphs 8A-8D also assume that the magnetizing inductance value of coupled inductor 228 is much greater than any leakage inductance value of coupled inductor 228. Graph 802 is a graph of switching node voltage Vₓ(1) versus time, and graph 804 is a graph of switching node voltage Vₓ(2) versus time. FIG. 8C is a graph 806 including a curve representing voltage at the injection switching node X(N+1), which is node X(3) because N is equal to two in this example. FIG. 8C also includes a curve representing voltage V_{o_z} at injection output node 222. FIG. 8D is a graph 808 of intermediate voltages V_{y} between magnetizing inductances Lₘ and leakage inductances Lₖ. Each intermediate voltage V_{y} has essentially the same value due to the magnetizing inductance value of coupled inductor 228 being very large relative to the leakage inductance values.

In the example of FIGS. 8A-8D, controller 206 controls injection stage 704 so that injection stage 704 switches in a manner which compensates for power transfer windings 210 being driven high. Specifically, injection winding 220 is driven high in response to any power transfer winding 210 being driven high, and injection winding 220 is driven low in response to any power transfer winding 210 being driven low, as illustrated in FIGS. 8A-8C. For example, injection winding 220 is driven high at time t₅ in response to power transfer winding 210(1) being driven high, and injection winding 220 is driven low at time to in response to power transfer winding 210(1) being driven low. Consequently, intermediate voltages V_{y} remain essentially constant at the value of Vₒ, as shown in FIG. 8D. Therefore, voltages V_{L} across leakage inductances Lₖ remain essentially at zero even as power transfer windings 210 are repeatedly driven between high and low states to regulate one or more parameters of switching power converter 700. As a result, there is no material ripple current associated with leakage inductance Lₖ, irrespective of operating duty cycle of switching power converter 700.

Similar to the example of FIGS. 5A-5D, the example of FIGS. 8A-8D assumes essentially ideal magnetic coupling of the windings of coupled inductor 228. However, injection stage 704 may significantly reduce ripple current magnitude even if non-ideal coupling of coupled inductor 228 prevents injection stage 704 from completely eliminating ripple current associated with leakage inductances Lₖ. Additionally, while FIGS. 8A-8D assume ideal timing, i.e., that injection stage 704 switches in synchronicity with power stages 202, timing may vary while still achieving acceptable operation of switching power converter 700.

Referring again to FIG. 2, injection stage 204 is powered from input power node 216, which enables injection stage 204 to properly operate with coupled inductor 228 being symmetrical. Coupled inductor 228 is symmetrical in that (a) injection winding 220 forms the same number of turns as each power transfer winding 210 and (b) reluctance of a magnetic flux path between injection winding 220 and any power transfer winding 210 is substantially the same as reluctance of a magnetic flux path between any two power transfer windings 210. Switching power converter 200 could be modified so that injection stage 204 is powered from a node having a voltage different from Vᵢₙ with appropriate changes to coupled inductor 228 so that the coupled inductor is no longer symmetrical.

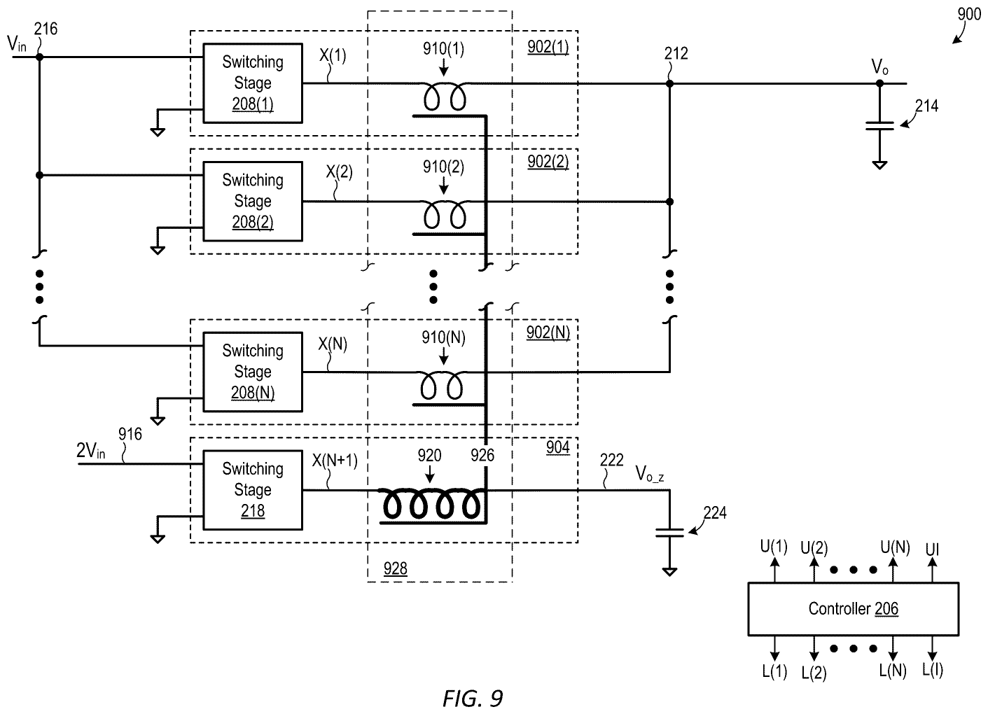

For example, FIG. 9 is a schematic diagram of a switching power converter 900, which is an alternate embodiment of switching power converter 200 where injection stage 204 is replaced with an injection stage 904 powered from an input power rail 916. Input power rail 916 is at twice the voltage of input power rail 216, i.e., input power rail 916 is at voltage 2Vᵢₙ. Therefore, symmetrical coupled inductor 228 is replaced with an asymmetrical coupled inductor 928 to compensate for the change in input voltage to injection stage 904. Coupled inductor 928 includes N power transfer windings 910 and one injection winding 920, where power transfer windings 910 are alternate embodiments of power transfer windings 210 and injection winding 920 is an alternate embodiment of injection winding 220. Coupled inductor 928 is asymmetrical in that injection winding 920 forms twice the number of turns as each power transfer winding 910, to compensate for the input voltage to injection stage 904 being twice the input voltage to each power transfer stage 902. Each power stage 902 is the same as a corresponding power stage 202 of FIG. 2, except that each power stage 902 includes a power transfer winding 910 of asymmetrical coupled inductor 928 instead of a power transfer winding 210 of symmetrical coupled inductor 228.

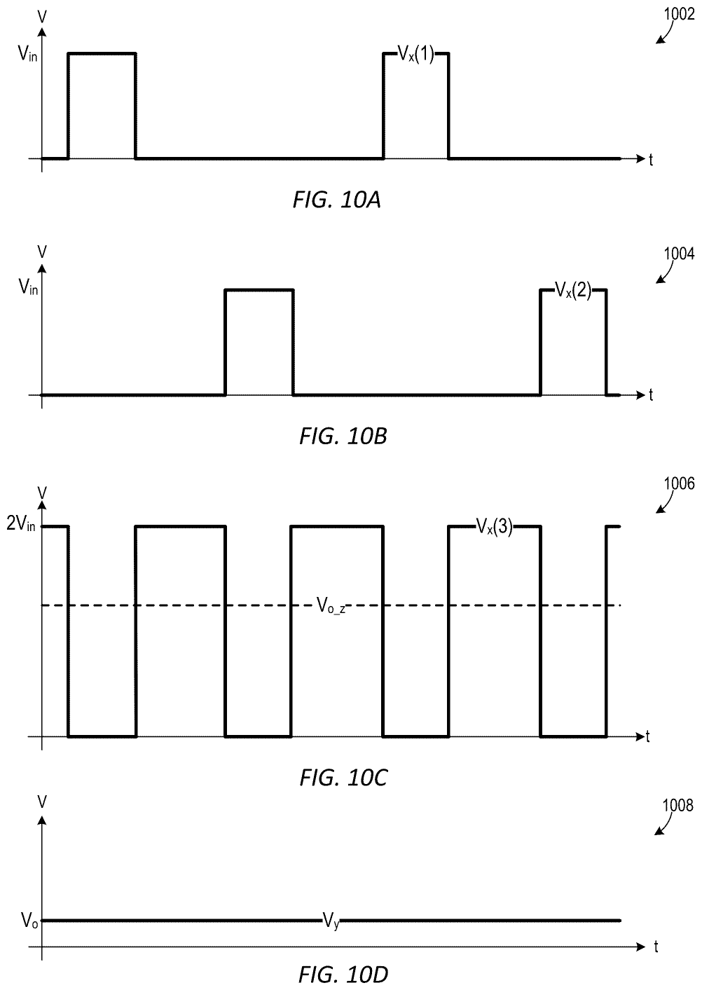

FIGS. 10A-10D are graphs collectively illustrating one example of operation of an embodiment of switching power converter 900 where N is equal to two, such that switching power converter 900 includes two power stages 902 and one injection stage 904. Graphs 10A-10D also assume that the magnetizing inductance value of coupled inductor 928 is much greater than any leakage inductance value of coupled inductor 928. Graph 1002 is a graph of switching node voltage Vₓ(1) versus time, and graph 1004 is a graph of switching node voltage Vₓ(2) versus time. FIG. 10C is a graph 1006 including a curve representing voltage at the injection switching node X(N+1), which is node X(3) because N is equal to two in this example. FIG. 10C also includes a curve representing voltage V_{o_2} at injection output node 222. FIG. 10D is a graph 1008 of intermediate voltages V_{y} between magnetizing inductances Lₘ and leakage inductances Lₖ, where coupled inductor 928 has an electrical model analogous to the FIG. 4 electrical model of coupled inductor 228. Each intermediate voltage V_{y} has essentially the same value due to the magnetizing inductance value of coupled inductor 928 being very large relative to the leakage inductance values.

In the example of FIGS. 10A-10D, controller 206 controls injection stage 904 so that injection stage 904 switches in a manner which compensates for power transfer windings 910 being driven low. Specifically, injection winding 920 is driven high in response to any power transfer winding 910 being driven low, and injection winding 920 is driven low in response to any power transfer winding 910 being driven high, as illustrated in FIGS. 10A-10C. Although injection switching node Vₓ(3) is driven to twice voltage Vᵢₙ instead of to voltage Vᵢₙ, the asymmetrical winding turn numbers of coupled inductor 928 compensate for this difference in input voltage. Consequently, intermediate voltages V_{y} remain essentially constant at the value of Vₒ, as shown in FIG. 10D. Therefore, voltages V_{L} across leakage inductances Lₖ remain essentially at zero even as power transfer windings 910 are repeatedly driven between high and low states to regulate one or more parameters of switching power converter 900. As a result, there is no material ripple current associated with leakage inductance Lₖ, irrespective of operating duty cycle of switching power converter 900.

Similar to the example of FIGS. 5A-5D, the example of FIGS. 10A-10D assumes essentially ideal magnetic coupling of the windings of coupled inductor 928. However, injection stage 904 may significantly reduce ripple current magnitude even if non-ideal coupling of coupled inductor 928 prevents injection stage 904 from completely eliminating ripple current associated with leakage inductances Lₖ. Additionally, while FIGS. 10A-10D assume ideal timing, i.e., that injection stage 904 switches in synchronicity with power stages 902, timing may vary while still achieving acceptable operation of switching power converter 900.

Referring again to FIG. 9, coupled inductor 928 could be modified so that it is asymmetrical in magnetic flux path reluctance, instead of in number of winding turns. For example, coupled inductor 928 could be replaced with an asymmetrical coupled inductor where all windings form the same number of turns, but where a magnetic flux path between the injection winding and any one power transfer winding has twice the reluctance of a magnetic flux path between any two power transfer windings.

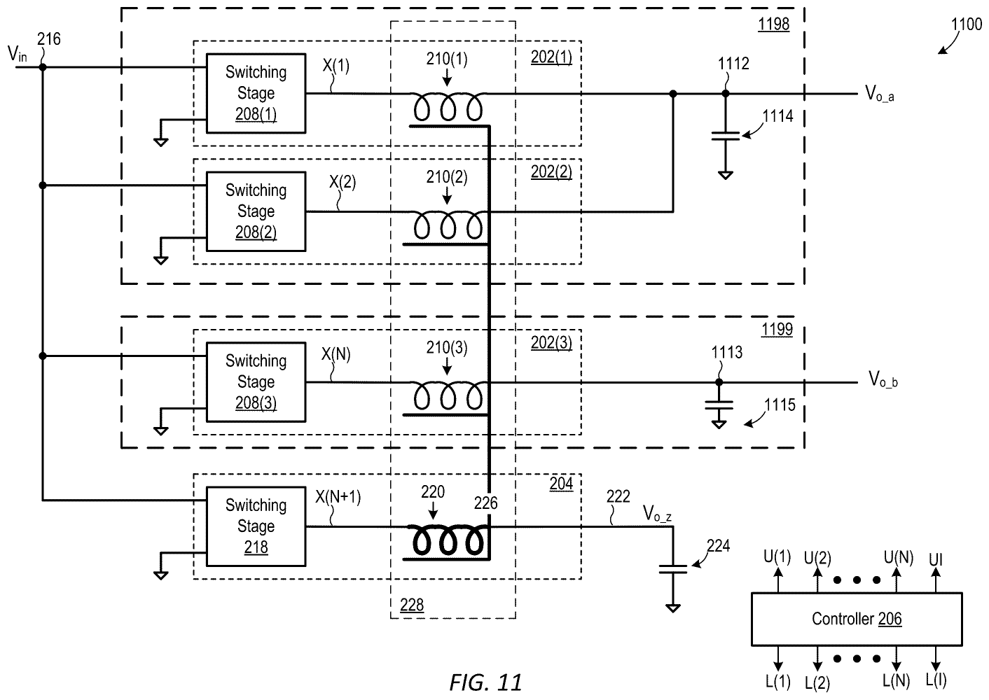

Any of the switching power converters disclosed herein could be modified so that at least two of the power stages are part of different respective power sub-converters. For example, FIG. 11 is a schematic diagram of a switching power converter 1100, which is an alternate embodiment of switching power converter 200 where N is equal to three and the switching power converter includes two power sub-converters 1198 and 1199. Power stages 202(1) and 202(2) are part of power sub-converter 1198, and each of these power stages is electrically coupled between input power node 216 and an output power node 1112 of power sub-converter 1198. Output power node 1112 is at a voltage V_{o_a}, and one or more capacitors 1114 are optionally electrically coupled to output power node 1112. Power stage 202(3) is part of power sub-converter 1199, and the power stage is electrically coupled between input power node 216 and an output power node 1113 of power sub-converter 1199. Output power node 1113 is at a voltage V_{o_b}, and one or more capacitors 1115 are optionally electrically coupled to output power node 1113.

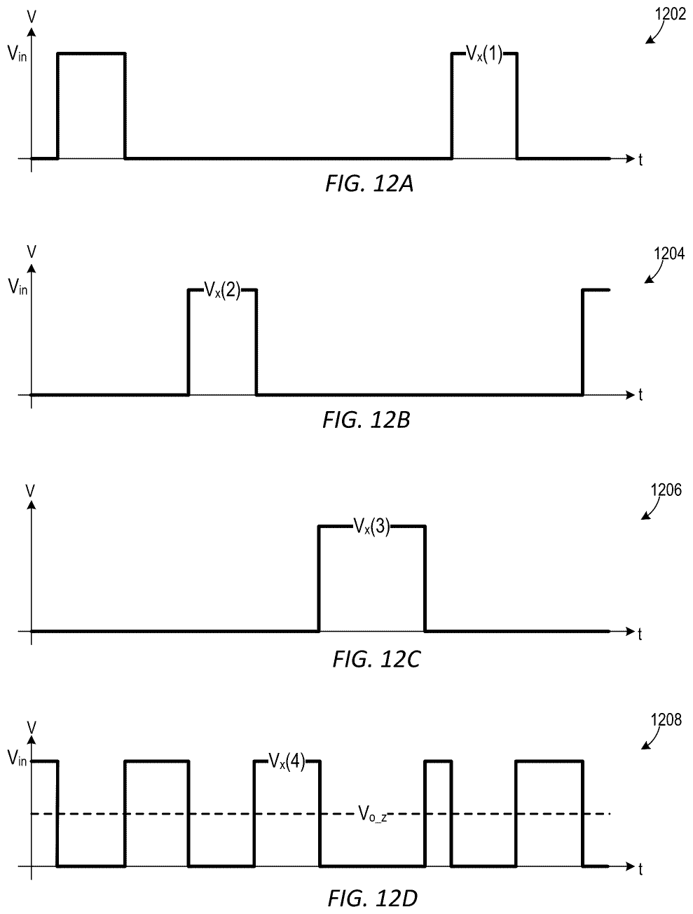

FIGS. 12A-12D are graphs collectively illustrating one example of operation of an embodiment of switching power converter 1100. Graphs 12A-12D assume that the magnetizing inductance value of coupled inductor 228 is much greater than any leakage inductance value of coupled inductor 228. Graph 1202 is a graph of switching node voltage Vₓ(1) versus time, graph 1204 is a graph of switching node voltage Vₓ(2) versus time, and graph 1206 is a graph of switching node voltage Vₓ(3) versus time. FIG. 12D is a graph 1208 including a curve representing voltage at the injection switching node X(N+1), which is node X(4) because N is equal to three in this example. FIG. 12D also includes a curve representing voltage V_{o_z} at injection output node 222. In this example, controller 206 controls injection stage 204 so that injection stage 204 switches in a manner which compensates for power transfer windings 210 being driven low. Specifically, injection winding 220 is driven high in response to any power transfer winding 210 being driven low, and injection winding 220 is driven low in response to any power transfer winding 210 being driven high, as illustrated in FIGS. 12A-12C. Consequently, voltages V_{L} across leakage inductances Lₖ remain essentially at zero even as power transfer windings 210 are repeatedly driven between high and low states to regulate one or more parameters of switching power converter 1100. As a result, there is no material ripple current associated with leakage inductance Lₖ, irrespective of operating duty cycle of switching power converter 200.

Similar to the example of FIGS. 5A-5D, the example of FIGS. 12A-12D assumes essentially ideal magnetic coupling of the windings of coupled inductor 228. However, injection stage 204 may significantly reduce ripple current magnitude even if non-ideal coupling of coupled inductor 228 prevents injection stage 204 from completely eliminating ripple current associated with leakage inductances Lₖ. Additionally, while FIGS. 12A-12D assume ideal timing, i.e., that injection stage 204 switches in synchronicity with power stages 202, timing may vary while still achieving acceptable operation of switching power converter 1100.

Switching power converter 1100 could be modified so that injection stage 204 compensates for a power transfer winding 210 being driven high, instead of compensating for a power transfer winding 210 being driven low, such as in a manner analogous to that discussed above with respect to FIGS. 7 and 8. Furthermore, switching power converter 1100 could be modified to include a different number of power stages 202, a different number of power sub-converters, and/or a different distribution of power stages 202 among power sub-converters. Additionally, two or more power sub-converters could be daisy chained, i.e., an output of one power sub-converter could be an input of another power sub-converter. The power sub-converters could also be of a different type, for example a buck power sub-converter could be coupled with a boost power sub-converter, etc.

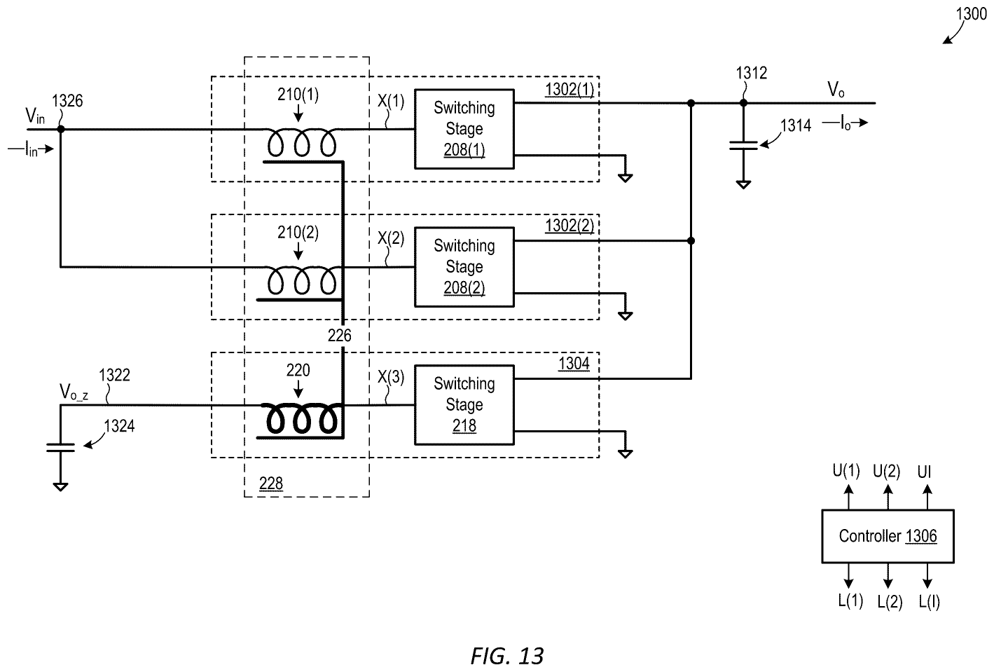

The example switching power converters discussed above have a multi-phase buck-type topology. However, the new switching power converters including injection stages are not limited to a buck-type topology. For example, FIG. 13 is a schematic diagram of a switching power converter 1300, which is an alternate embodiment of switching power converter 200 having a multi-phase boost-type topology, where N is equal to two. Power stages 202 of converter 200 are replaced with power stages 1302 in converter 1300. Power stages 1302 include the same constituent elements as power stages 202, but with the elements configured in a different topology.

Specifically, each power transfer winding 210 is electrically coupled between an input power node 1326 and a switching node X of the respective power stage 1302. The upper and lower switching devices of each power switching stage 208, e.g., switching devices 306 and 308 of FIG. 3, are electrically coupled in series between an output power node 1312 and ground. Accordingly, each power switching stage 208 is configured to repeatedly switch its respective switching node X between a voltage Vₒ of output power node 1312 and ground. A given power transfer winding 210 in converter 1300 is driven high when its respective switching node X is at voltage Vₒ, and the power transfer winding 210 is driven low when its respective switching node X is at zero volts relative to ground. For example, power transfer winding 210(1) is driven high when switching node X(1) is at voltage Vₒ, and power transfer winding 210(1) is driven low when switching node X(1) is at zero volts relative to ground. One or more capacitors 1314 are optionally electrically coupled to output power node 1312.

Injection stage 204 of converter 200 is replaced with an injection stage 1304 in converter 1300. Injection stage 1304 includes the same constituent elements as injection stage 204 but with a different topology. Injection winding 220 is electrically coupled between injection switching node X(3) and an injection output node 1322, and a capacitor 1324 is electrically coupled to injection output node 1322. The upper and lower switching devices of injection switching stage 218, e.g., switching devices 310 and 312 of FIG. 3, are electrically coupled in series between output power node 1312 and ground. Accordingly, injection switching stage 218 is configured to repeatedly switch switching node X(3) between voltage Vₒ and ground. Injection winding 220 in converter 1300 is driven high when switching node X(3) is at voltage Vₒ, and the injection winding is driven low when switching node X(3) is at zero volts relative to ground.

Controller 1306, which is an embodiment of controller 206, is configured to generate control signals U and L to control duty cycle of power stages 1302 to regulate at least one parameter of switching power converter 1300. Examples of possible regulated parameters include, but are not limited, magnitude of input voltage Vᵢₙ, magnitude of input current Iᵢₙ, magnitude of output voltage Vₒ, and magnitude of output current Iₒ. Controller 1306 is optionally configured to generate control signals U and L such that power stages 1302 switch out-of-phase with each other. Controller 1306 is further configured to generate control signals UI and LI to control injection stage 1304 such that the injection stage injects magnetic flux in magnetic core 226 in a manner which reduces voltage across a respective leakage inductance of each power transfer winding 210, such as by compensating for a power transfer winding 210 be driven high or by compensating for a power transfer winding 210 being driven low.

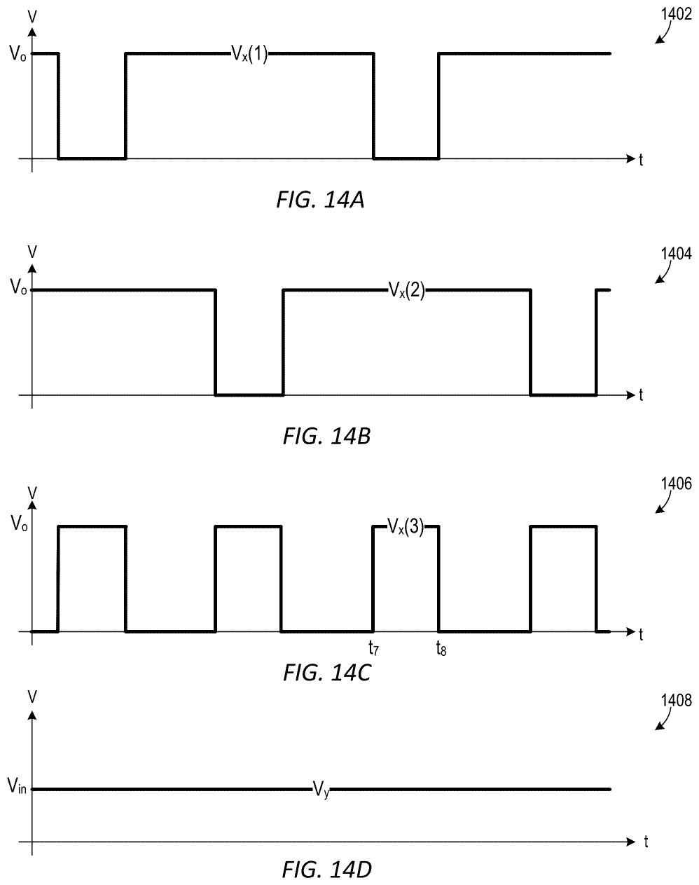

For example, FIGS. 14A-14D are graphs collectively illustrating one example of operation of an embodiment of switching power converter 1300. Graphs 14A-14D assume that the magnetizing inductance value of coupled inductor 228 is much greater than any leakage inductance value of coupled inductor 228. Graph 1402 is a graph of switching node voltage Vₓ(1) versus time, and graph 1404 is a graph of switching node voltage Vₓ(2) versus time. FIG. 14C is a graph 1406 including a curve representing voltage at the injection switching node X(3). FIG. 14D is a graph 1408 of intermediate voltages V_{y} between magnetizing inductances Lₘ and leakage inductances Lₖ. Each intermediate voltage V_{y} has essentially the same value due to the magnetizing inductance value of coupled inductor 228 being very large relative to the leakage inductance values.

In the example of FIGS. 14A-14D, controller 1306 controls injection stage 1304 so that injection stage 1304 switches in a manner which compensates for power transfer windings 210 being driven low. Specifically, injection winding 220 is driven high in response to any power transfer winding 210 being driven low, and injection winding 220 is driven low in response to any power transfer winding 210 being driven high, as illustrated in FIGS. 14A-14C. For example, injection winding 220 is driven high at time t₇ in response to power transfer winding 210(1) being driven low, and injection winding 220 is driven low at time to in response to power transfer winding 210(1) being driven high. Consequently, intermediate voltages V_{y} remain essentially constant at the value of Vᵢₙ, as shown in FIG. 14D. Therefore, voltages V_{L} across leakage inductances Lₖ remain essentially at zero even as power transfer windings 210 are repeatedly driven between high and low states to regulate one or more parameters of switching power converter 1300. As a result, there is no material ripple current associated with leakage inductance Lₖ, irrespective of operating duty cycle of switching power converter 1400.

Similar to the example of FIGS. 5A-5D, the example of FIGS. 14A-14D assumes essentially ideal magnetic coupling of the windings of coupled inductor 228. However, injection stage 1304 may significantly reduce ripple current magnitude even if non-ideal coupling of coupled inductor 228 prevents injection stage 1304 from completely eliminating ripple current associated with leakage inductances Lₖ. Additionally, while FIGS. 14A-14D assume ideal timing, i.e., that injection stage 1304 switches in synchronicity with power stages 1302, timing may vary while still achieving acceptable operation of switching power converter 1300.

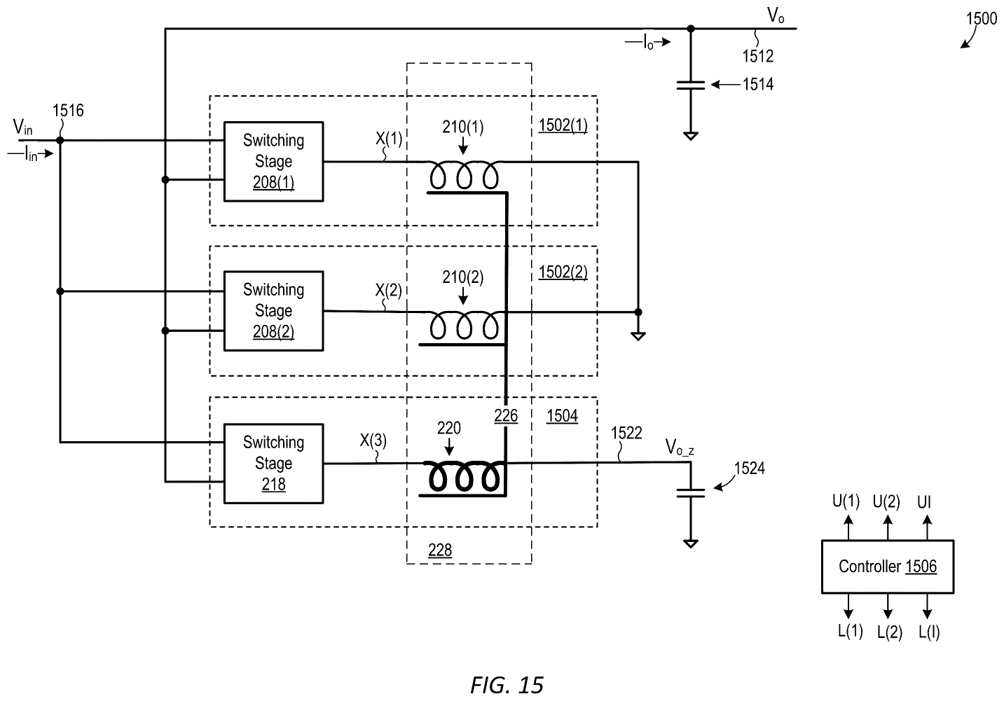

FIG. 15 is a schematic diagram of a switching power converter 1500, which is an alternate embodiment of switching power converter 200 having a multi-phase buck-boost-type topology, where N is equal to two. Power stages 202 of converter 200 are replaced with power stages 1502 in converter 1500. Power stages 1502 include the same constituent elements as power stages 202, but with the elements configured in a different topology. Specifically, each power transfer winding 210 is electrically coupled between ground and a switching node X of the respective power stage 1502. The upper and lower switching devices of each power switching stage 208, e.g., switching devices 306 and 308 of FIG. 3, are electrically coupled in series between an input power node 1516 and an output power node 1512. Accordingly, each power switching stage 208 is configured to repeatedly switch its respective switching node X between a voltage Vᵢₙ of input power node 1516 a voltage Vₒ of output power node 1512. A given power transfer winding 210 in converter 1500 is driven high when its respective switching node X is at voltage Vᵢₙ, and the power transfer winding 210 is driven low when its respective switching node X is at voltage Vₒ. For example, power transfer winding 210(1) is driven high when switching node X(1) is at voltage Vᵢₙ, and power transfer winding 210(1) is driven low when switching node X(1) is at voltage Vₒ. One or more capacitors 1514 are optionally electrically coupled to output power node 1512.

Injection stage 204 of converter 200 is replaced with an injection stage 1504 in converter 1500. Injection stage 1504 includes the same constituent elements as injection stage 204 but with a different topology. Injection winding 220 is electrically coupled between injection switching node X(3) and an injection output node 1522, and a capacitor 1524 is electrically coupled to injection output node 1522. The upper and lower switching devices of injection switching stage 218, e.g., switching devices 310 and 312 of FIG. 3, are electrically coupled in series between input power node 1516 and output power node 1512. Accordingly, injection switching stage 218 is configured to repeatedly switch switching node X(3) between voltage Vᵢₙ and Vₒ. Injection winding 220 in converter 1500 is driven high when switching node X(3) is at voltage Vᵢₙ, and the injection winding is driven low when switching node X(3) is at voltage Vₒ.

Controller 1506, which is an embodiment of controller 206, is configured to generate control signals U and L to control duty cycle of power stages 1502 to regulate at least one parameter of switching power converter 1500. Examples of possible regulated parameters include, but are not limited, magnitude of input voltage Vᵢₙ, magnitude of input current Iᵢₙ, magnitude of output voltage Vₒ, and magnitude of output current Iₒ. Controller 1506 is optionally configured to generate control signals U and L such that power stages 1502 switch out-of-phase with each other. Controller 1506 is further configured to generate control signals UI and LI to control injection stage 1504 such that the injection stage injects magnetic flux in magnetic core 226 in a manner which reduces voltage across a respective leakage inductance of each power transfer winding 210, such as by compensating for a power transfer winding 210 be driven high or by compensating for a power transfer winding 210 being driven low.

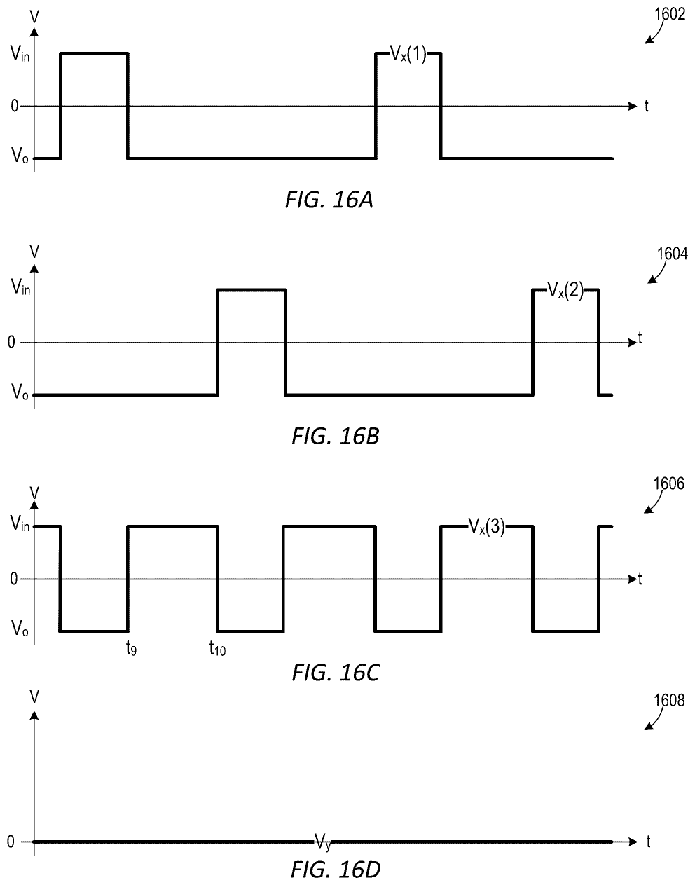

For example, FIGS. 16A-16D are graphs collectively illustrating one example of operation of an embodiment of switching power converter 1500. Graphs 16A-16D assume that the magnetizing inductance value of coupled inductor 228 is much greater than any leakage inductance value of coupled inductor 228. Graph 1602 is a graph of switching node voltage Vₓ(1) versus time, and graph 1604 is a graph of switching node voltage Vₓ(2) versus time. FIG. 16C is a graph 1606 including a curve representing voltage at the injection switching node X(3). FIG. 16D is a graph 1608 of intermediate voltages V_{y} between magnetizing inductances Lₘ and leakage inductances Lₖ. Each intermediate voltage V_{y} has essentially the same value due to the magnetizing inductance value of coupled inductor 228 being very large relative to the leakage inductance values.

In the example of FIGS. 16A-16D, controller 1506 controls injection stage 1504 so that injection stage 1504 switches in a manner which compensates for power transfer windings 210 being driven low. Specifically, injection winding 220 is driven high in response to any power transfer winding 210 being driven low, and injection winding 220 is driven low in response to any power transfer winding 210 being driven high, as illustrated in FIGS. 16A-16C. For example, injection winding 220 is driven high at time ty in response to power transfer winding 210(1) being driven low, and injection winding 220 is driven low at time t₁₀ in response to power transfer winding 210(2) being driven high. Consequently, intermediate voltages V_{y} remain essentially constant at zero volts, as shown in FIG. 16D. Therefore, voltages V_{L} across leakage inductances Lₖ remain essentially at zero even as power transfer windings 210 are repeatedly driven between high and low states to regulate one or more parameters of switching power converter 1500. As a result, there is no material ripple current associated with leakage inductance Lₖ, irrespective of operating duty cycle of switching power converter 1500.

Similar to the example of FIGS. 5A-5D, the example of FIGS. 16A-16D assumes essentially ideal magnetic coupling of the windings of coupled inductor 228. However, injection stage 1504 may significantly reduce ripple current magnitude even if non-ideal coupling of coupled inductor 228 prevents injection stage 1504 from completely eliminating ripple current associated with leakage inductances Lₖ. Additionally, while FIGS. 16A-16D assume ideal timing, i.e., that injection stage 1504 switches in synchronicity with power stages 1502, timing may vary while still achieving acceptable operation of switching power converter 1500.

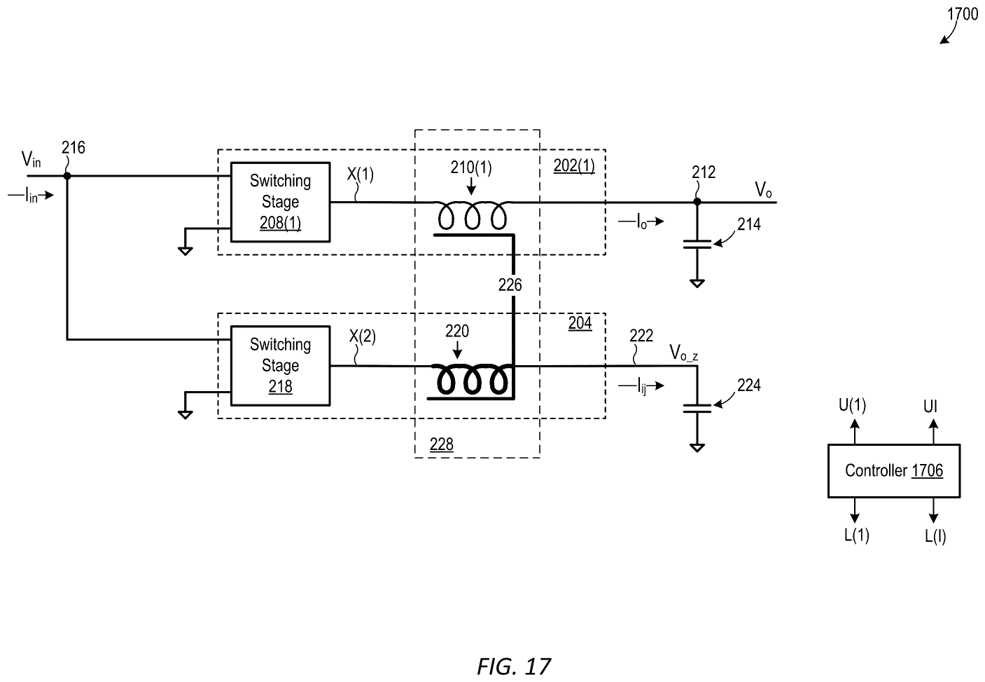

Any of the multi-phase switching power converters including injection stages could be modified to be a single-phase switching power converter. For example, FIG. 17 is a schematic diagram of a switching power converter 1700, which is an alternate embodiment of switching power converter 200 where N is equal to one. Accordingly, switching power converter 1700 is a single-phase switching power converter including one power stage 202(1) and one injection stage 204. Additionally, coupled inductor 228 includes only two windings—i.e., one power transfer winding 210(1) and one injection winding 220.

Controller 1706, which is an embodiment of controller 206, is configured to generate control signals U and L to control duty cycle of power stage 202(1) to regulate at least one parameter of switching power converter 1700. Examples of possible regulated parameters include, but are not limited, magnitude of input voltage Vᵢₙ, magnitude of input current Iᵢₙ, magnitude of output voltage Vₒ, and magnitude of output current Iₒ. Controller 1706 is further configured to generate control signals UI and LI to control injection stage 204 such that the injection stage injects magnetic flux in magnetic core 226 in a manner which reduces voltage across a leakage inductance of power transfer winding 210(1), such as by compensating for power transfer winding 210(1) be driven high or by compensating for a power transfer winding 210(1) being driven low.

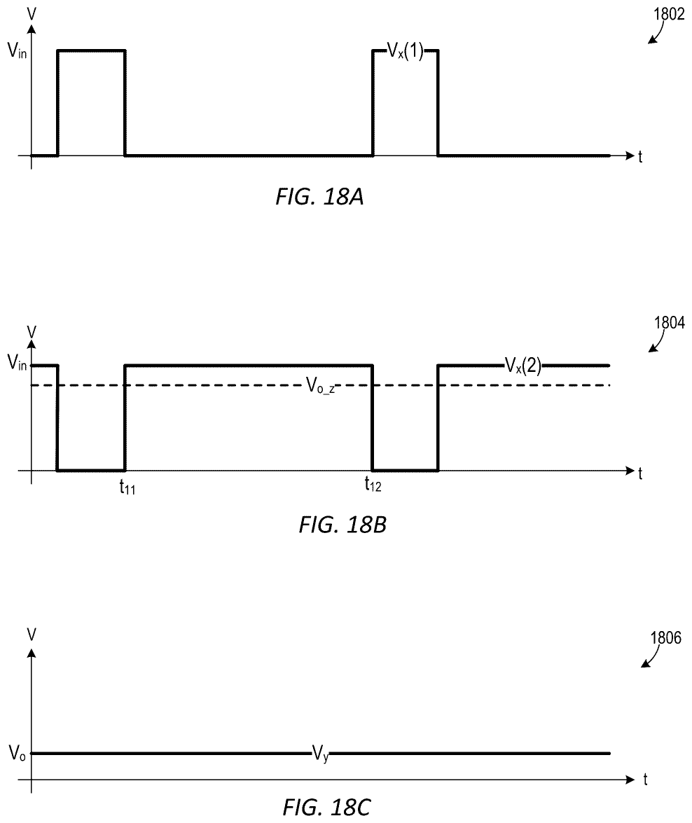

For example, FIGS. 18A-18C are graphs collectively illustrating one example of operation of an embodiment of switching power converter 1700. Graphs 18A-18C assume that the magnetizing inductance value of coupled inductor 228 is much greater than leakage inductance value of coupled inductor 228. Graph 1802 is a graph of switching node voltage Vₓ(1) versus time. FIG. 18B is a graph 1804 of intermediate voltages V_{y} between magnetizing inductances Lₘ and leakage inductances Lₖ. In the example of FIGS. 18A-18C, controller 1706 controls injection stage 204 so that the injection stage switches in a manner which compensates for power transfer winding 210(1) being driven low. Specifically, injection winding 220 is driven high in response to power transfer winding 210(1) being driven low, and injection winding 220 is driven low in response to power transfer winding 210(1) being driven high, as illustrated in FIGS. 18A and 18B. For example, injection winding 220 is driven high at time t₁₁ in response to power transfer winding 210(1) being driven low, and injection winding 220 is driven low at time t₁₂ in response to power transfer winding 210(1) being driven high. Consequently, intermediate voltage V_{y} remains essentially constant at output voltage Vₒ, as shown in FIG. 18C. Therefore, voltages V_{L} across leakage inductance Lₖ remain essentially at zero even as power transfer winding 210(1) is repeatedly driven between its high and low states to regulate one or more parameters of switching power converter 1700. As a result, there is no material ripple current associated with leakage inductance Lₖ, irrespective of operating duty cycle of switching power converter 1700.

Similar to the example of FIGS. 5A-5D, the example of FIGS. 18A and 18B assumes essentially ideal magnetic coupling of the windings of coupled inductor 228. However, injection stage 204 may significantly reduce ripple current magnitude even if non-ideal coupling of coupled inductor 228 prevents injection stage 204 from completely eliminating ripple current associated with leakage inductance Lₖ. Additionally, while FIGS. 18A-18C assume ideal timing, i.e., that injection stage 204 switches in synchronicity with power stage 202, timing may vary while still achieving acceptable operation of switching power converter 1700.

Referring again to FIG. 17, switching power converter 1700 has a buck-type topology. However, switching power converter 1700 could be modified to have a different type of topology, including but not limited to a boost-type topology or a buck-boost type topology.

While the injection stages of the new switching power converters achieve significant benefits, they may degrade switching power converter transient response. Accordingly, some embodiments of controllers 206, 1306, 1506, and 1706 are configured to disable the injection stage of their respective switching power converter in response to a signal indicating the switching power converter is experiencing a transient event, such as a significant change in load or a significant change in input voltage. In some embodiments, controllers 206, 1306, 1506, and 1706 internally generate the signal indicating the power converter is experiencing a transient event, and in some other embodiments, controllers 206, 1306, 1506, and 1706 receive such signal from an external source. Alternately, some embodiments of controllers 206, 1306, 1506, and 1706 are configured to change timing of the injection stage of their respective switching power converter in response to a signal indicating the switching power converter is experiencing a transient event, such as to help the converter quickly respond to the transient event.

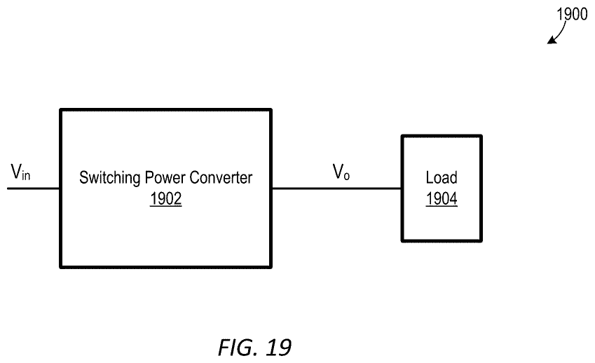

FIG. 19 is a block diagram of an electrical system 1900, which is one possible application of the new switching power converters disclosed herein. System 1900 includes a switching power converter 1902 configured to power a load 1904. Switching power converter 1902 may be any one of the new switching power converters disclosed herein. For example, switching power converter 1902 may be any one of switching power converters 200, 700, 900, 1100, 1300, 1500, and 1700. Load 1904 includes, for example, one or more integrated circuits, including but not limited to, a processing unit (e.g. a central processing unit (CPU) or a graphics processing unit (GPU)), a field programmable gate array (FPGA), an application specific integrated circuit (ASIC) (e.g. for artificial intelligence and/or machine learning), and/or a memory unit.

### Experimental Results

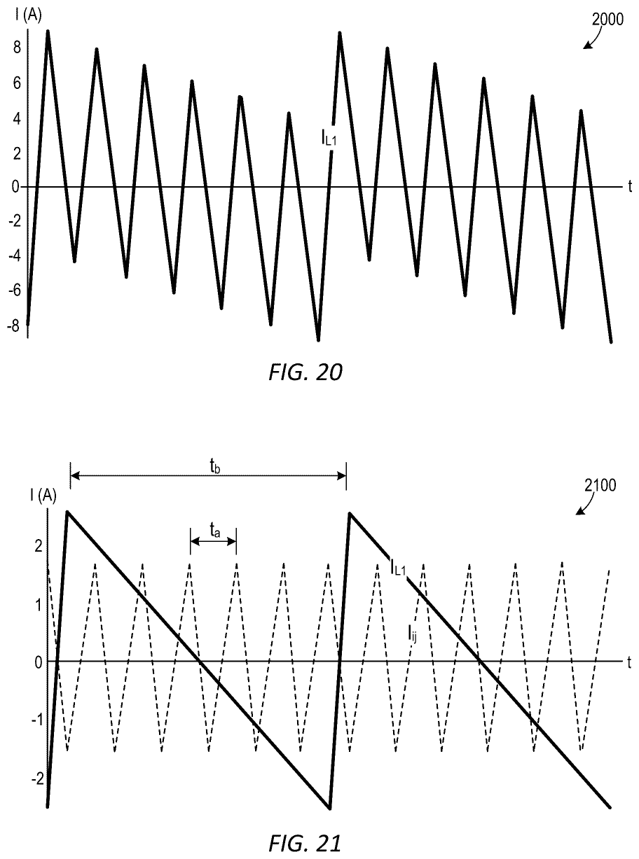

Discussed below with respect to FIGS. 20-25 are computer simulations of several embodiments of the new switching power converters with injection stages. It is realized, though, that the new switching power converters are not limited to performing according to these simulations.

FIG. 20 is a graph 2000 of power stage 202(1) current I_{L1} (see FIG. 2) versus time in an embodiment of switching power converter 200 where (a) N is equal to six, (b) magnetizing inductance is 300 nanohenries (nH), (c) each leakage inductance is 15 nH, (d) switching frequency is 400 kilohertz (KHz) per power stage, and (d) injection stage 204 is disabled. This example shows a Vin=12V, Vo=0.8V application. As shown in FIG. 20, peak-to-peak ripple current associated with leakage inductance is relatively large, i.e., over 12 amperes. Additionally, there is a ripple current component associated with magnetizing inductance. FIG. 21 is a graph 2100 of current versus time of the same power converter that was simulated in graph 2000 but with injection stage 204 enabled. FIG. 21 includes a curve representing current I_{L1} as well as a curve representing current Iᵢⱼ (see FIG. 2) through injection stage 204. Current Iᵢⱼ has a frequency 1/tₐ which is equal to the switching frequency of the switching power converter. However, injection stage 204 eliminates ripple current resulting from leakage inductances, such that the only ripple current component in current I_{L1} is ripple current associated with magnetizing inductance of coupled inductor 228. The ripple current associated with magnetizing inductance has a much smaller peak-to-peak value of approximately six amperes, as well as a much smaller frequency of 1/t_{b}. Thus, the simulations of FIGS. 20 and 21 show that injection stage 204 is capable of significantly reducing ripple current magnitude. Additionally, it should be noted that the simulations of FIGS. 20 and 21 do not assume ideal magnetic coupling of coupled inductor 228—instead, the ratio of magnetizing inductance to leakage inductance is 20 in these simulations. Performance would improve with a larger ratio of magnetizing inductance to leakage inductance.

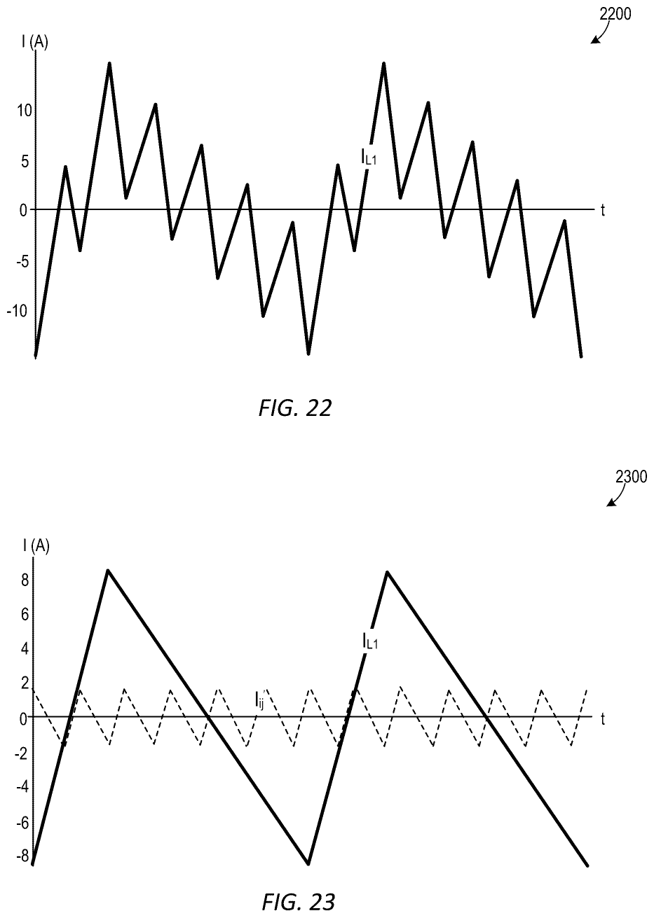

FIGS. 22 and 23 illustrate an operating example of the same switching power converter as simulated with respect to FIGS. 20 and 21 but with larger duty cycle so that switching node waveforms overlap. This example shows a Vin=12V, Vo=3.3V application. Specifically, FIG. 22 is a graph 2200 of power stage 202(1) current I_{L1} versus time with injection stage 204 disabled, and FIG. 23 is graph 2300 of each of current I_{L1} and current Iᵢⱼ versus time within injection stage 204 enabled. These two graphs show that injection stage 204 reduced peak-to-peak ripple current magnitude from approximately 29 amperes to 16 amperes. The relative reduction in ripple current magnitude is smaller than in the example of FIGS. 20 and 21 because a portion of total ripple current that is associated with magnetizing inductance increases within increasing duty cycle.

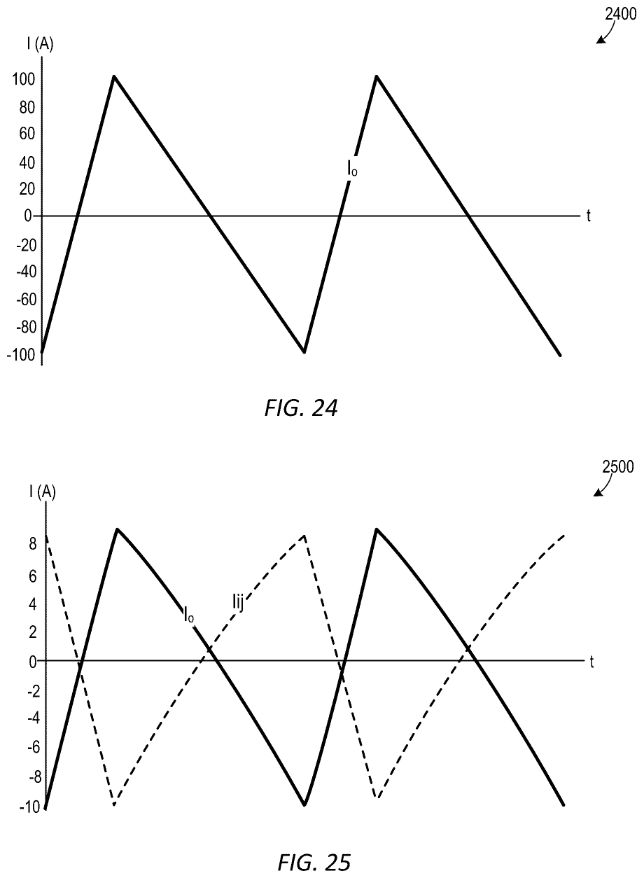

FIG. 24 is a graph 2400 of output current Iₒ versus time in an embodiment of single-phase switching power converter 1700 where (a) magnetizing inductance is 300 nH, (b) each leakage inductance is 15 nH, (c) switching frequency is 400 kilohertz KHz, and (d) injection stage 204 is disabled. This example shows a Vin=12V, Vo=3.3V application. Peak-to-peak ripple current magnitude is very large in this example, i.e., peak-to-peak ripple current magnitude is approximately 200 amperes. FIG. 25 is a graph 2100 of current versus time of the same power converter that was simulated in graph 2400 but with injection stage 204 enabled. FIG. 25 includes a curve representing current Iₒ as well as a curve representing current Iᵢⱼ. Peak-to-peak ripple current is only approximately 19 amperes with injection stage 204 enabled, thereby further showing that injection stage 204 is effective in reducing ripple current magnitude.

### Asymmetrical Coupled Inductors

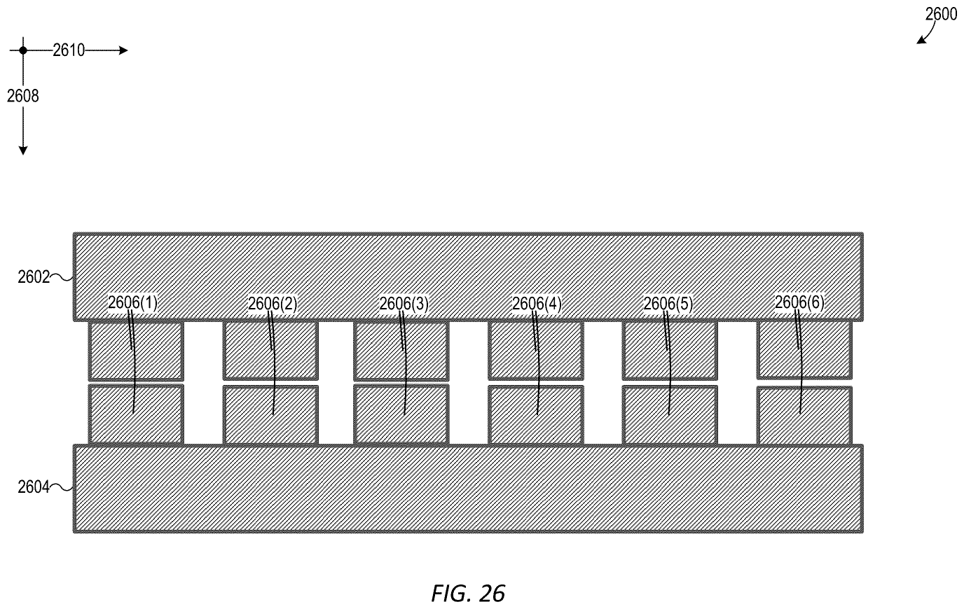

Referring again to FIG. 2, Applicant has found that it may be advantageous for coupled inductor 228 to be configured such that a portion of magnetic core 226 including injection winding 220 has a higher saturation current rating than portions of magnetic core 226 including power transfer windings 210. Consider FIG. 26, which is a plan view of a magnetic core 2600. Magnetic core 2600 is one possible embodiment of magnetic core 226 where N is equal to five, i.e., where the magnetic core supports five power transfer windings 210 and one injection winding 220. Magnetic core 2600 has a “ladder” configuration. Accordingly, magnetic core 2600 includes a first rail 2602, a second rail 2604 and N+1 rungs 2606, where first rail 2602, second rail 2604, and rungs 2606 are formed of a magnetic material, such as a ferrite magnetic material and/or a powered iron magnetic material. First rail 2602 and second rail 2604 are separated from each other in a direction 2608, and each rung 2606 is disposed between first rail 2602 and second rail 2604 in direction 2608. Each rung 2606 is separated from each other rung 2606 in a direction 2610, where direction 2610 is orthogonal to direction 2608. While not required, each rung 2606 may form a gap in direction 2608, such as illustrated in FIG. 26. A respective power transfer winding 210 (not shown in FIG. 26) may be wound around each rung 2606(1)-2606(5), and an injection winding 220 (not shown in FIG. 26) may be wound around rung 2606(6). Accordingly, magnetic core 2600 is capable of magnetically coupling five power transfer windings 210 and one injection winding 220. The shown core has no dedicated leakage features, such as leakage plates on top, or leakage rungs side by side with main rungs 2606(1)-2606(5) associated with power transfer windings. Accordingly, magnetic core 2600 is optimized for the largest mutual inductance between the windings in a given size, as expected current ripple cancellation is very high and the leakage value can therefore be set to a minimum value. However, if an increased leakage value is needed, dedicated leakage features can be added to the core. For example, a leakage plate can be added to the top of magnetic core 2600, or leakage rungs can be added on the side of main rungs 2606(1)-2606(5).

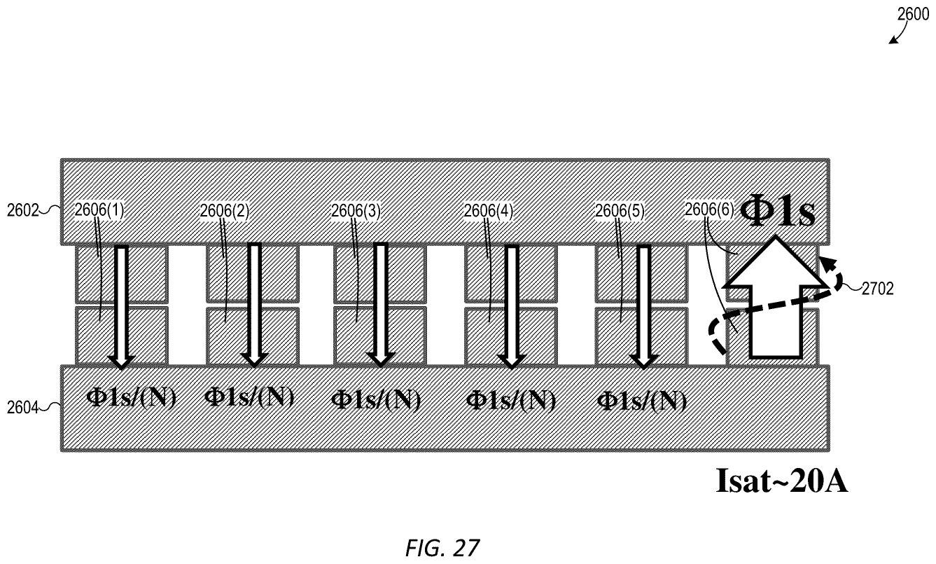

Magnetic core 2600 is configured such that each rung 2606 has a saturation current rating of 20 amperes, when a single-turn winding is wound around the rung. FIG. 27 is a plan view of magnetic core 2600 illustrating an example of magnetic flux flow resulting from a current 2702 of 20 Amperes flowing through a single-turn injection winding (not shown) wound around rung 2606(6). This current generates a magnetic flux of Φ1s flowing through rung 2606(6). Assume that this flux Φ1s corresponds to the maximum flux before saturation of the rung 2606(6). Magnetic flux Φ1s is equally divided among remaining rungs 2606(1)-2606(5), and a magnetic flux of Φ1s/N therefore flows through each rung 2606(1)-2605(5). Accordingly, magnetic core 2600 operates within its saturation current rating when a current of 20 Amperes flows through a single-turn injection winding wound around rung 2606(6).

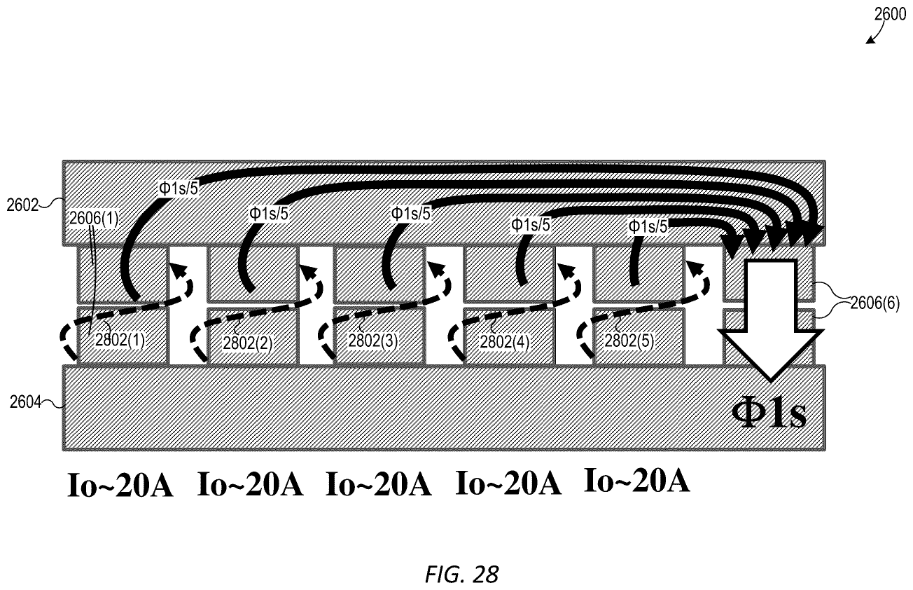

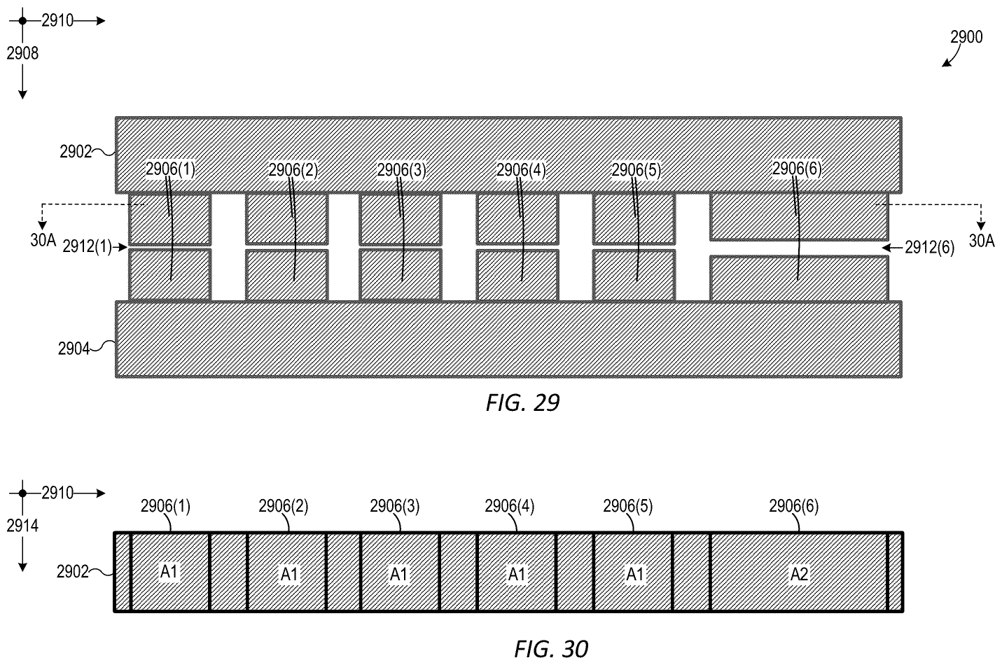

In contrast, consider FIG. 28, which is a plan view of magnetic core 2600 where a current 2802 of 20 amperes flows simultaneously through a respective power transfer winding (not shown) wound around each rung 2606(1)-2606(5). Only two instances of rungs 2606, i.e., rungs 2606(1) and 2606(6), are labeled in FIG. 28 for illustrative clarity. Each current 2802 generates a magnetic flux of Φ1s flowing through its respective rung 2606, and each such flux is then divided by returning through the other rungs. The FIG. 28 example has five currents 2802 generating five fluxes, and each flux is divided into five approximately equal parts in return paths in rungs 2606. Accordingly, magnetic fluxes Φ1s/N combine in rung 2606(6), such that a magnetic flux of N*Φ1s/N=Φ1s flows through rung 2606(6). This implies that the maximum current in the main phases (corresponding to rungs 2606(1)-2606(5)) has to be limited to the current that saturates Lₘ in a single rung 2606 of the core in FIGS. 27 and 28. Typically, Iₛₐₜ of Lₘ is much smaller as compared to the Iₛₐₜ rating of a coupled inductor where all phases carry the same load current and only much smaller leakage inductance is exposed to that load current (a common DC component of the load current cancels flux in Lₘ when all phases have the same Iₒ/phase). Increasing the load range of the coupled inductor with injection phase in FIGS. 27 and 28 is therefore desired.

This limitation on power transfer winding current magnitude can be mitigated by increasing saturation current rating of rung 2606(6) relative to remaining rungs 2606(1)-2606(5) of magnetic core 2600, such as by increasing cross-sectional area of rung 2606(6). For example, FIG. 29 is a plan view of an asymmetrical magnetic core 2900, which is similar to magnetic core 2600 but where one rung has a larger cross-sectional area than the remaining rungs. FIG. 30 is a cross-sectional view of magnetic core 2900 taken along line 30A-30A of FIG. 29. Magnetic core 2900 includes a first rail 2902, a second rail 2904, and N+1 rungs 2906, where N is equal to five in this embodiment. First rail 2902, second rail 2904, and rungs 2906 are formed of a magnetic material, such as a ferrite magnetic material and/or a powered iron magnetic material.

First rail 2902 and second rail 2904 are separated from each other in a direction 2908, and each rung 2906 is disposed between first rail 2902 and second rail 2904 in direction 2908. Each rung 2906 is separated from each other rung 2906 in a direction 2910, where direction 2910 is orthogonal to direction 2908. While not required, each rung 2906 may form a gap 2912 in direction 2908. Only two instances of gaps 2912, i.e., gaps 2912(1) and 2912(6), are labeled in FIG. 29 for illustrative clarity. In certain embodiments, a thickness of gap 2912(6) in direction 2908 is greater than a respective thickness of each other gap 2912 in direction 2908, such as to help reduce susceptibility of rung 2906(6) to magnetic saturation.

As illustrated in FIG. 30, each rung 2906(1)-2906(5) has a cross-sectional area A1 in a plane extending in direction 2910 and in a direction 2914, where direction 2914 is orthogonal to each of directions 2908 and 2910. Additionally, rung 2906(6) has a cross-sectional area A2 in a plane extending in directions 2910 and 2914. Importantly, cross-sectional area A2 is greater than cross-sectional area A1. The relatively large cross-sectional area A2 of rung 2906(6) raises the saturation current rating of rung 2906(6) relative to other rungs 2906(1)-2906(5), which advantageously increases permissible simultaneous current magnitude of power transfer windings wound around rungs 2906(1)-2906(5), relative to magnetic core 2600 of FIG. 26. Accordingly in certain embodiments, maximum permissible magnitude of current simultaneously flowing through each power transfer winding must not exceed Iₛₐₜ, instead of being limited to Iₛₐₜ/N.

The number of rungs 2906 of magnetic core 2900 may vary without departing from the scope hereof. Additionally, while FIGS. 29 and 30 illustrate magnetic core 2900 as having rectangular cross-sectional areas, magnetic core 2900 could be modified so that one or more portions of the magnetic core have different-shaped cross-sectional areas, such as rounded-rectangular cross-sectional areas. Additionally, while each of rungs 2906(1)-2906(5) has an identical configuration in magnetic core 2900, magnetic core 2900 could be modified so that two or more rungs 2906(1)-2906(5) have different respective configurations, such as different cross-sectional areas. The shown core has no dedicated leakage features, such as leakage plates on top, or leakage rungs side by side with the main rungs 2906(1)-2906(5) associated with power transfer windings. Accordingly, magnetic core 2900 is optimized for the largest mutual inductance between the windings in a given size, as expected current ripple cancellation is very high and the leakage value can be set to a minimum value. However, if an increased leakage value is needed, one or more dedicated leakage features can be added to magnetic core 2900, including but not limited to a leakage plate on top of the core and/or leakage rungs on the side of rungs 2906(1)-2906(5).

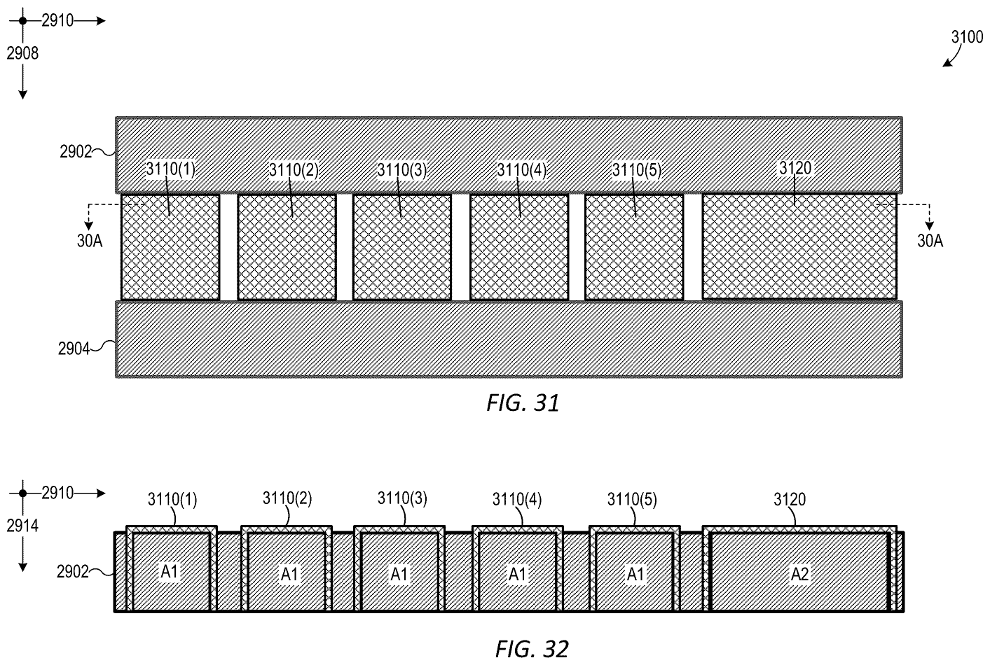

FIG. 31 is a top plan view of a coupled inductor 3100, which is one embodiment of a coupled inductor including an instance of magnetic core 2900 of FIGS. 29 and 30. FIG. 32 is a cross-sectional view of coupled inductor 3100 taken along line 32A-32A of FIG. 31. Coupled inductor 3100 includes a respective power transfer winding 3110 wound around each rung 2906(1)-2906(5), as well as an injection winding 3120 wound around rung 2906(6). Power transfer windings 3110 are embodiments of power transfer windings 210 of FIG. 2, and injection winding 3120 is an embodiment of injection winding 220 of FIG. 2. Accordingly, coupled inductor 3100 is one possible embodiment of coupled inductor 228 of FIG. 2.

Although FIGS. 31 and 32 depict windings 3110 and 3120 as being single-turn metallic foil windings, any of these windings could have a different configuration. For example, one or more of windings 3110 and 3120 could be metallic wire windings instead of metallic foil windings. As another example, one or more of windings 3110 and 3120 could be multi-turn windings.

Coupled Inductors with a Single Winding Configuration

While coupled inductor 3100 of FIGS. 31 and 32 may advantageously support large magnitude of current simultaneously flowing through each power transfer winding 3110, coupled inductor 3100 has a couple of potential drawbacks. First, injection winding 3120 has a different configuration than power transfer windings 3110 due to rung 2906(6) having a larger cross-sectional area than each of rungs 2906(1)-2906(5). As such, coupled inductor 3100 requires two different winding configurations, which may result in relatively high design complexity, component procurement difficulty, manufacturing difficulty, and cost. Additionally, most of the leakage magnetic flux must flow through rung 2906(6), irrespective of its location in magnetic core 2900, which results in high leakage magnetic flux density in portions of magnetic core 2900 near rung 2906(6). High leakage magnetic flux density, in turn, results in high magnetic core losses.

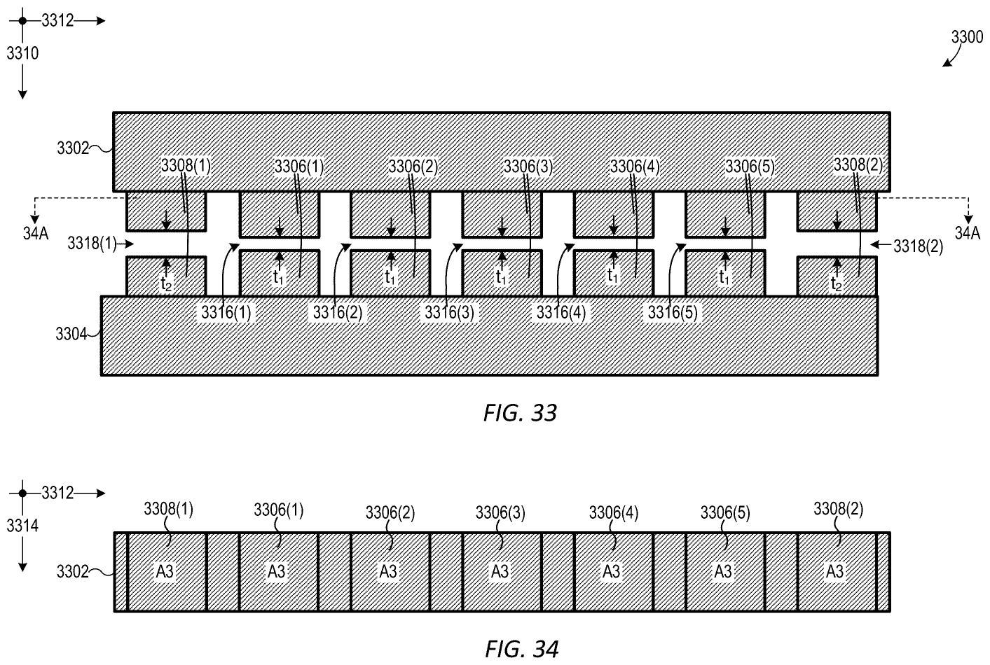

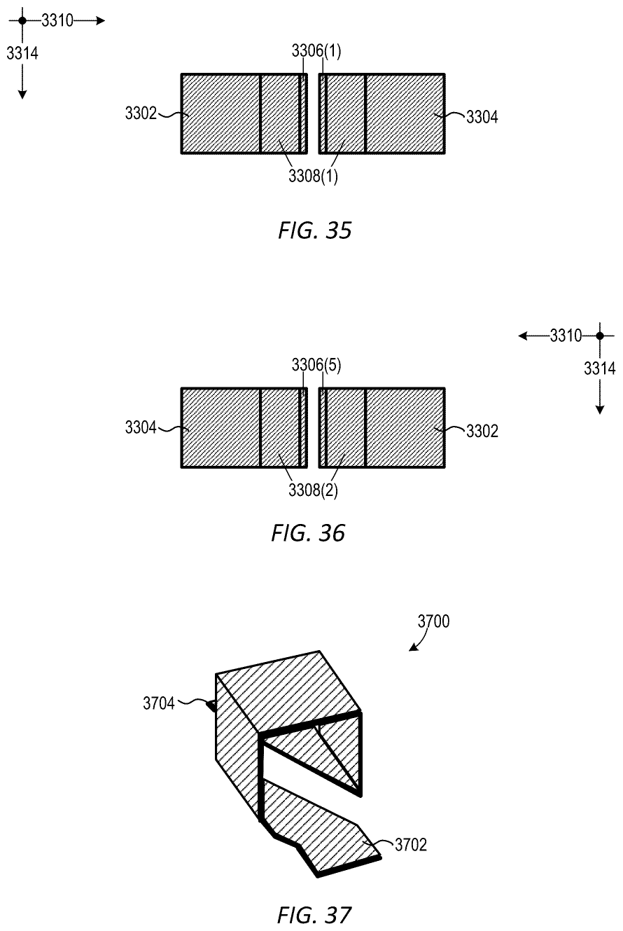

Discussed below with respect to FIGS. 33-45 are coupled inductors with a single winding configuration which at least partially overcome the above-discussed drawbacks of coupled inductor 3100 by enabling a single winding configuration to be used for both power transfer windings and injection windings. The new coupled inductors may be used in switching power converters including injection stages, such as in any one of switching power converter 200 (FIG. 2), switching power converter 700 (FIG. 7), switching power converter 1100 (FIG. 11), switching power converter 1300 (FIG. 13), switching power converter 1500 (FIG. 15), and switching power converter 1700 (FIG. 17). FIGS. 33-36 collectively illustrate one embodiment of a magnetic core that may be used in particular embodiments of these coupled inductors. Specifically, FIG. 33 is a top plan view of a magnetic core 3300, FIG. 34 is a cross-sectional view of magnetic core 3300 taken along line 34A-34A of FIG. 33, FIG. 35 is a left side elevational view of magnetic core 3300, and FIG. 36 is a right side elevational view of magnetic core 3300. Magnetic core 3300 is an embodiment of magnetic core 226 (FIG. 2) where N is equal to five, although it is understood that magnetic core 3300 could be modified to support different values of N, as discussed below.

Magnetic core 3300 includes a first rail 3302, a second rail 3304, a plurality of power transfer rungs 3306, and a plurality of injection rungs 3308. First rail 3302, second rail 3304, power transfer rungs 3306, and injection rungs 3308 are formed, for example, of a ferrite magnetic material and/or an iron powder magnetic material. First rail 3302 and second rail 3304 are separated from each other in a first direction 3310. Each power transfer rung 3306 is disposed between first rail 3302 and second rail 3304 in first direction 3310, and each power transfer rung 3306 is separated from each other power transfer rung 3306 in a second direction 3312 that is orthogonal to first direction 3310. Additionally, each injection rung 3308 is disposed between first rail 3302 and second rail 3304 in first direction 3310, and each injection rung 3308 is separated from each other injection rung 3308, as well as from each power transfer rung 3306, in second direction 3312. Accordingly, magnetic core 3300 has a ladder configuration. FIGS. 34-36 further illustrate a third direction 3314 that is orthogonal to each of first direction 3310 and second direction 3312.

While not required, is anticipated that (i) each power transfer rung 3306 will typically form a respective gap 3316 having a thickness t₁ in first direction 3310 and (ii) each injection rung 3308 will typically form a respective gap 3318 having a second thickness t₂ in first direction 3310. However, gaps 3316 and 3318 may not be needed in embodiments where magnetic core 3300 is formed of a magnetic material having a distributed gap, such as iron powder within a binder. Additionally, while not required, it is anticipated that second thickness t₂ of gaps 3318 will typically be different from, e.g., greater than, first thickness t₁ of gaps 3316, such as illustrated in FIG. 33.

The number of power transfer rungs 3306 and injection rungs 3308 may vary without departing from the scope hereof. For example, the number of power transfer rungs 3306 may vary with the value of N in a switching power converter including magnetic core 3300, and the number of injection rungs 3308 may increase within increasing value of N and decrease with decreasing value of N. Additionally, while FIGS. 33-36 illustrate magnetic core 3300 as having rectangular cross-sectional areas, magnetic core 3300 could be modified so that one or more portions of magnetic core 330 have different-shaped cross-sectional areas, such as rounded-rectangular cross-sectional areas. Magnetic core 3300 is illustrated as not including dedicated leakage features, such as leakage plates on top, or leakage rungs side by side with power transfer rungs 3306. Accordingly, magnetic core 3300 is optimized for the largest mutual inductance between the windings in a given size, as expected current ripple cancellation is very high and the leakage value can be set to a minimum value. However, if an increased leakage value is needed, one or more dedicated leakage features can be added to magnetic core 3300, including but not limited to a leakage plate on top of the magnetic core and/or leakage rungs on the side of power transfer rungs 3306.

As illustrated in FIG. 34, each power transfer rung 3306, as well as each injection rung 3308, has a cross-sectional area A3 in a plane extending in second direction 3312 and in third direction 314. As such, injection rungs 3308 have the same cross-sectional areas as power transfer rungs 3306 in a plane extending in second direction 3312 and in third direction 3314. Such common cross-sectional area A3 among all rungs in magnetic core 3300 enables respective windings wound around power transfer rungs 3306 and respective windings wound around injection rungs 3308 to have a common size. Accordingly, while not required, magnetic core 3300 may be used in a coupled inductor where power transfer windings and injection windings have a common a configuration, e.g., where each power transfer windings and each injection winding have a common shape, size, and thickness. For example, FIG. 37 is a perspective view of a winding 3700 that may be wound around either a power transfer rung 3306 of magnetic core 3300 or an injection rung 3308 of magnetic core 3300. As such, an instance of winding 3700 may serve as either a power transfer winding or an injection winding, depending on which rung of magnetic core 3300 that the instance of winding 3700 is wound around. Winding 3700 includes solder tabs 3702 and 3704 at respective ends of winding 3700,

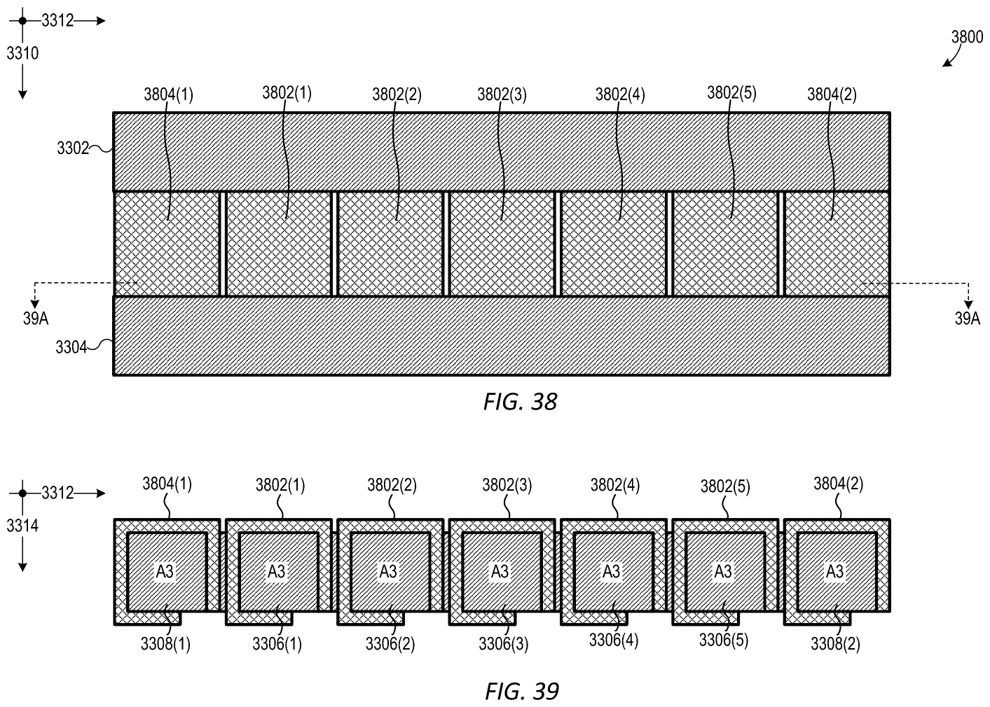

FIGS. 38 and 39 illustrate a coupled inductor 3800, where coupled inductor 3800 includes magnetic core 3300 of FIGS. 33-36 and a plurality of instances of winding 3700 of FIG. 37. FIG. 38 is a top plan view of coupled inductor 3800 and FIG. 39 is a cross-sectional view of coupled inductor 3800 taken along line 39A-39A of FIG. 38. A respective power transfer winding 3802 is wound around each power transfer rung 3306, and a respective injection winding 3804 is wound around each injection rung 3308. Each power transfer winding 3802, as well as each injection winding 3804, is a respective instance of winding 3700 of FIG. 37. Consequently, power transfer windings 3802 and injection windings 3804 have a common configuration, e.g., a common shape, size, and thickness. As such, power transfer windings 3802 and injection windings 3804 are interchangeable during assembly of coupled inductor 3800, or stated differently, a given instance of winding 3700 of FIG. 37 could be used as either a power transfer winding 3802 or an injection winding 3804 when assembling coupling inductor 3800. Each power transfer winding 3804 is magnetically coupled with each other power transfer winding 3802 by magnetic core 3300. Additionally, each injection winding 3804 is magnetically coupled with each other injection winding 3804 by magnetic core 3300. Furthermore, each power transfer winding 3802 is magnetically coupled with each injection winding 3804 by magnetic core 3300.

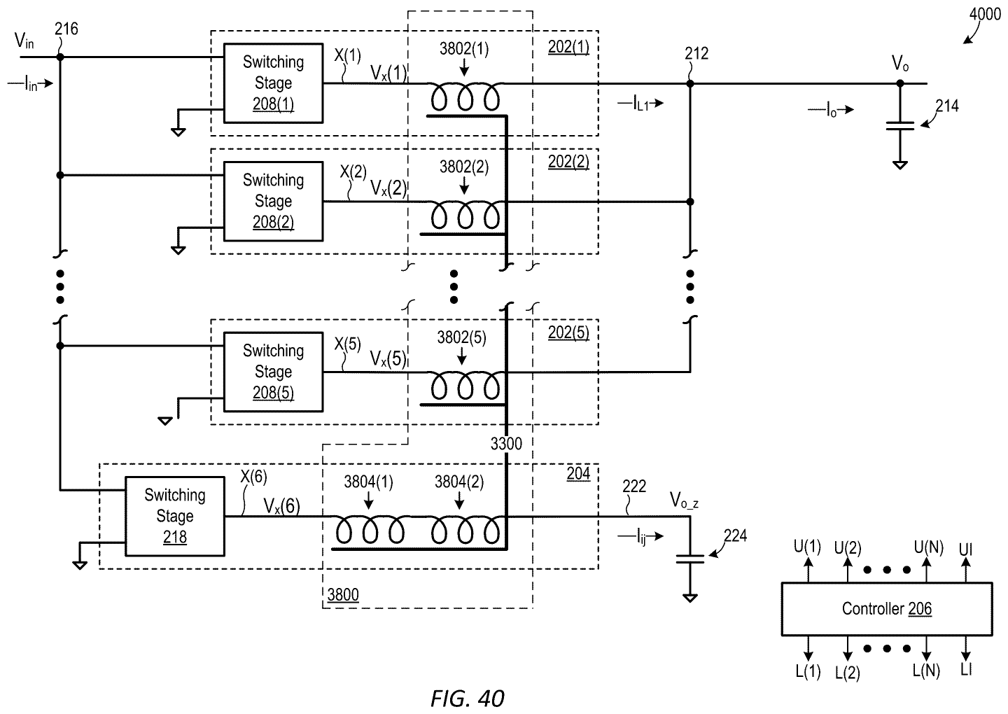

All injection windings 3804 are electrically coupled in series when coupled inductor 3800 is used in the above-discussed switching power converters including injection stages, which achieves a 1:1 turns ratio between power transfer windings 3802 and injection windings 3804. For example, FIG. 40 is a schematic diagram of a multi-phase switching power converter 4000, which is an embodiment of switching power converter 200 (FIG. 2) where (i) N is equal to five and (ii) coupled inductor 228 is embodied by coupled inductor 3800 (FIGS. 38-39). As illustrated in FIG. 40, power transfer windings 210(1) through 210(5) are embodied by power transfer windings 3802(1) though 3802(5), respectively. Additionally, injection winding 220 is embodied by the combination of injection winding 3804(1) and 3804(2) electrically coupled in series between switching node X(6) and injection output node 222. Accordingly, injection windings 3804 are driven high when switching node X(6) is at voltage Vᵢₙ, and injection windings 3804 are driven low when switching node X(6) is at zero volts relative to ground. Furthermore, magnetic core 226 is embodied by magnetic core 3300. Switching power converter 4000 operates in the same manner as switching power converter 200. For example, controller 206 generates control signals U and L to control duty cycle of power stages 202 to regulate at least one parameter of switching power converter 4000. As another example, controller 206 generates control signals UI and LI to control injection stage 204 such that the injection stage injects magnetic flux in magnetic core 3300 in a manner which reduces voltage across a respective leakage inductance of each power transfer winding 3802.

Switching power converter 4000 could be modified so that N is an integer other than five by changing the quantity of power stages 202 and corresponding switching stages 208, power transfer rungs 3306, and power transfer windings 3802. Furthermore, the quantity of injection windings 3804 electrically coupled in series between switching node X(6) and injection output node 222 in switching power converter 4000 will vary with the quantity of injection windings of coupled inductor 3800. For example, if coupled inductor 3800 were modified to include a third injection rung 3308 and corresponding third injection winding 3804, injection winding 3804(1), injection winding 3804(2), and the third injection winding 3804 would be electrically coupled in series between switching node X(6) and injection output node 222 in switching power converter 4000. As another example, if coupled inductor 3800 were modified to omit injection rung 3308(2) and corresponding injection winding 3804(2), solely injection winding 3804(1) would be electrically coupled between switching node X(6) and injection output node 222 in switching power converter 4000.

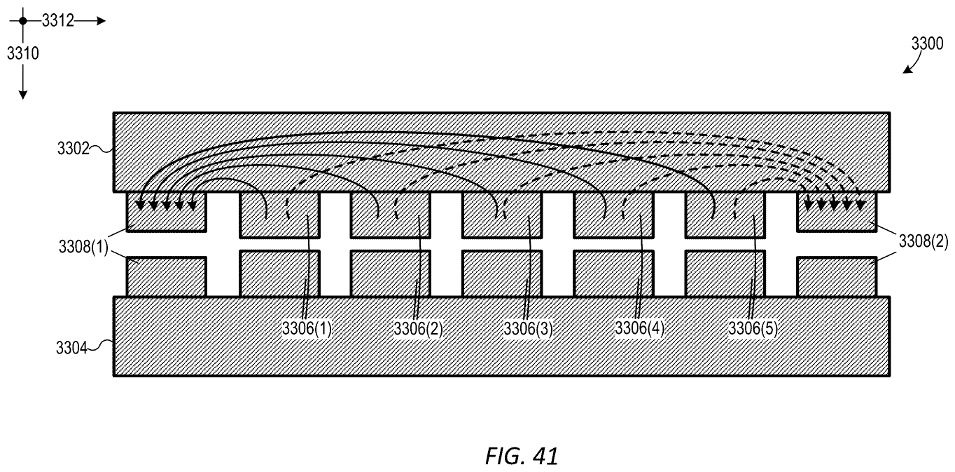

Referring again to FIGS. 38 and 39, it should be appreciated that coupled inductor 3800 achieves significant advantages. For example, the fact that each power transfer winding 3802 and each injection winding 3804 has a common configured promotes case of design of coupled inductor 3800, case of winding procurement for coupled inductor 3800, each of manufacturing of coupled inductor 3800, and low cost of coupled inductor 3800. Additionally, the fact that particular embodiments of coupled inductor 3800 include a plurality of injection rungs 3308 helps promote low leakage magnetic flux density in magnetic core 3300, which in turn promotes low core losses in magnetic core 3300. For example, FIG. 41 is a top plan view of magnetic core 3300 that is marked-up to symbolically show leakage magnetic flux in magnetic core 3300. The solid lines with arrows represent leakage magnetic flux flowing through injection rung 3308(1), and the dashed lines with arrows represent leakage magnetic flux flowing through injection rung 3308(2). As can be appreciated from FIG. 41, the fact that there are two paths for leakage magnetic flux in magnetic core 3300, i.e., through each of injection rung 3308(1) and injection rung 3308(2), promotes spreading of leakage magnetic flux in magnetic core 3300, thereby promoting low leakage magnetic flux density in magnetic core 3300. Additionally, the fact that injection rung 3308(1) and injection rung 3308(2) are on opposing ends of magnetic core 3300 in second direction 3312 causes respective leakage magnetic flux flowing each of the two injection rungs to flow in opposing directions in first rail 3302 and in second rail 3304, which results in partial leakage magnetic flux cancelation in first rail 3302 and second rail 3304. Such partial cancelation of leakage magnetic flux in first rail 3302 and second rail 3304 further promotes low leakage magnetic flux density in magnetic core 3300.

Referring again to FIGS. 38 and 39, although power transfer windings 3802 and injection windings 3804 are single-turn metallic foil windings, these windings could have a different configuration. For example, power transfer windings 3802 and injection windings 3804 could be metallic wire windings instead of metallic foil windings. As another example, power transfer windings 3802 and injection windings 3804 could be multi-turn windings instead of single-turn windings. Additionally, power transfer windings 3802 and injection windings 3804 could be modified in other manners, such as to have a different shape, to change the configuration of solder tabs 3702 and 3704, to omit solder tabs 3702 and 3704, to include through-hole pins in place of solder tabs 3702 and 3704, etc. Furthermore, while it is generally desirable that power transfer windings 3802 and injection windings 3804 have a common configuration, in some alternate embodiments, power transfer windings 3802 and injection windings 3804 have only a substantially similar configuration such that there are minor differences between power transfer windings 3802 and injection windings 3804.

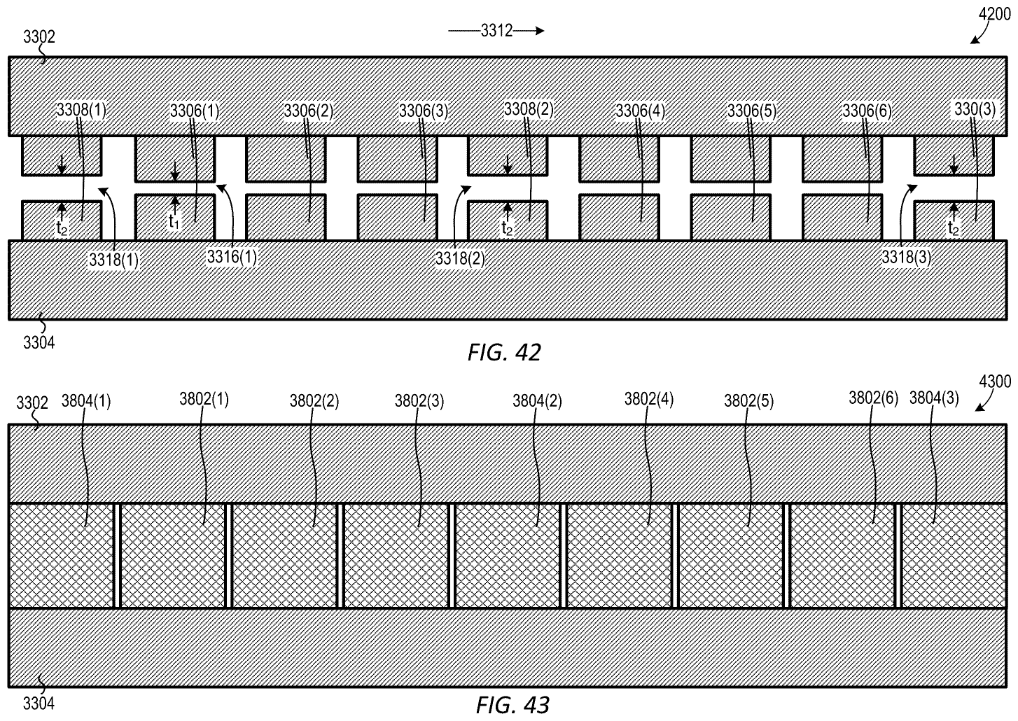

Additionally, coupled inductor 3800 could be modified to have a different quantity of power transfer windings 3802 and/or injection windings 3804. While not required, it is anticipated that quantity of injection windings 3804 will roughly scale with quantity of power transfer windings 3802. For example, FIG. 42 is a top plan view of a magnetic core 4200, which is an alternate embodiment of magnetic core 3300 including an additional power transfer rung 3306 and an additional injection rung 3308. Injection rungs 3308 are evenly distributed along magnetic core 4200 in second direction 3312 to promote low leakage magnetic flux density in magnetic core 4200. Only one instance of gap 3316 and first thickness t₁ are labeled in FIG. 42 for illustrative clarity. FIG. 43 is a top plan view of a coupled inductor 4300, which is an alternate embodiment of coupled inductor 3800 where magnetic core 3300 is replaced with magnetic core 4200, such that N is equal to six and coupled inductor 4300 includes three injection windings 3804.

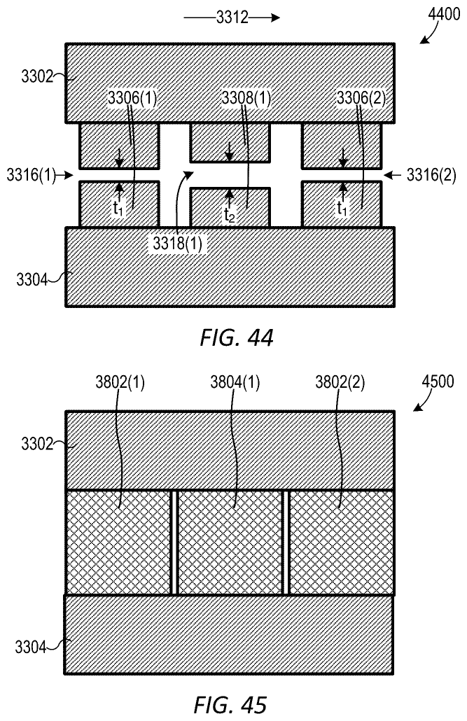

As another example, of how quantity of power transfer windings 3802 and injection windings 3804 may vary, FIG. 44 is a top plan view of a magnetic core 4400, which is an alternate embodiment of magnetic core 3300 including only two power transfer rungs 3306 and only one injection rung 3308. Injection rung 3308 is centrally located in magnetic core 4400 between power transfer rung 3306(1) and power transfer rung 3306(2) in second direction 3312, to promote low leakage magnetic flux density in magnetic core 4400. FIG. 45 is a top plan view of a coupled inductor 4500, which is an alternate embodiment of coupled inductor 3800 where magnetic core 3300 is replaced with magnetic core 4400, such that N is equal to two and coupled inductor 4500 includes only one injection winding 3804.

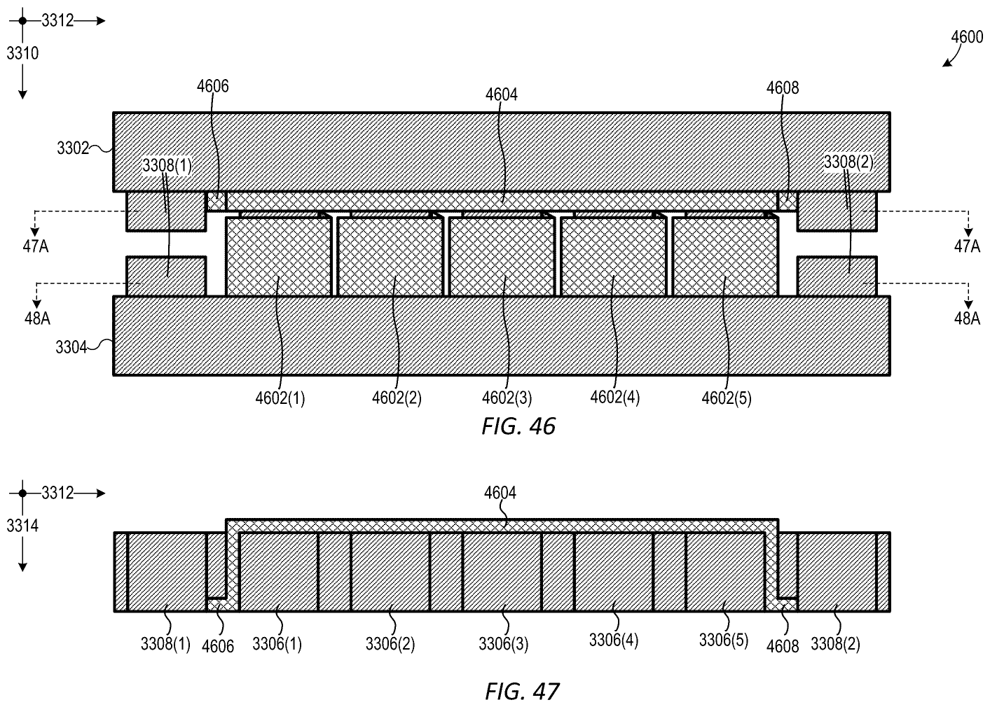

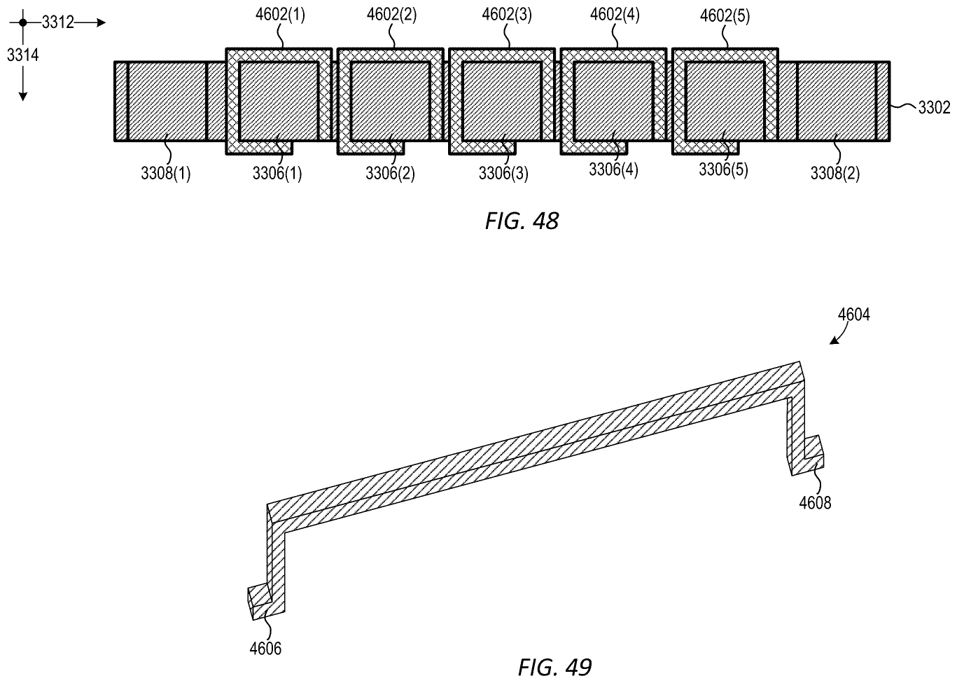

Referring again to FIG. 38, coupled inductor 3800 could be modified to replace injections windings 3804 with a single injection winding wound around all power transfer rungs, with the potential downside of the single injection winding having a different configuration than power transfer windings 3802. For example, FIG. 46 is a top plan view of a coupled inductor 4600, which is an alternate embodiment of coupled inductor 3800 including a single injection winding 4604 in place of injection windings 3804. FIG. 47 is a cross-sectional view of coupled inductor 4600 taken along line 47A-47A of FIG. 46, and FIG. 48 is a cross-sectional view of coupled inductor 4600 taken along line 48A-48A of FIG. 46. FIG. 49 is a perspective view of injection winding 4604. Injection winding 4604 is wound around all power transfer rungs 3306 such that injection winding 4604 forms a turn around all power transfer rungs 3306, but injection winding 4604 is not wound around injection rungs 3308. Injection winding 4604 forms respective solder tabs 4606 and 4608 at opposing ends of injection winding 4604. Coupled inductor 4600 also includes power transfer windings 4602 in place of power transfer windings 3802, where (i) each power transfer winding 4602 is wound around a respective power transfer rung 3306 and (ii) each power transfer winding 4602 is similar to power transfer winding 3700 of FIG. 37. However, each power transfer winding 4602 is slightly smaller than power transfer winding 3700 to leave space for injection winding 4604 to be wound around all power transfer rungs 3306.

Mutual magnetic flux from each power transfer winding 4602 flows through the turn of injection winding 4604. However, net mutual magnetic flux flowing through injection winding 4604 may be zero in some applications, e.g. mutual magnetic flux from some power transfer windings 4602 may cancel mutual magnetic flux from other power transfer windings 4602 in injection winding 4604, such that injection winding 4604 “sees” zero mutual magnetic flux. Additionally, injection winding 4604 is strongly magnetically coupled to leakage magnetic flux associated with power transfer windings 4602. Consequently, injection winding 4604 is electrically similar to, or even essentially electrically identical to, the series combination of injection windings 3804 of coupled inductor 3800, when used in a switching power converter including an injection stage.

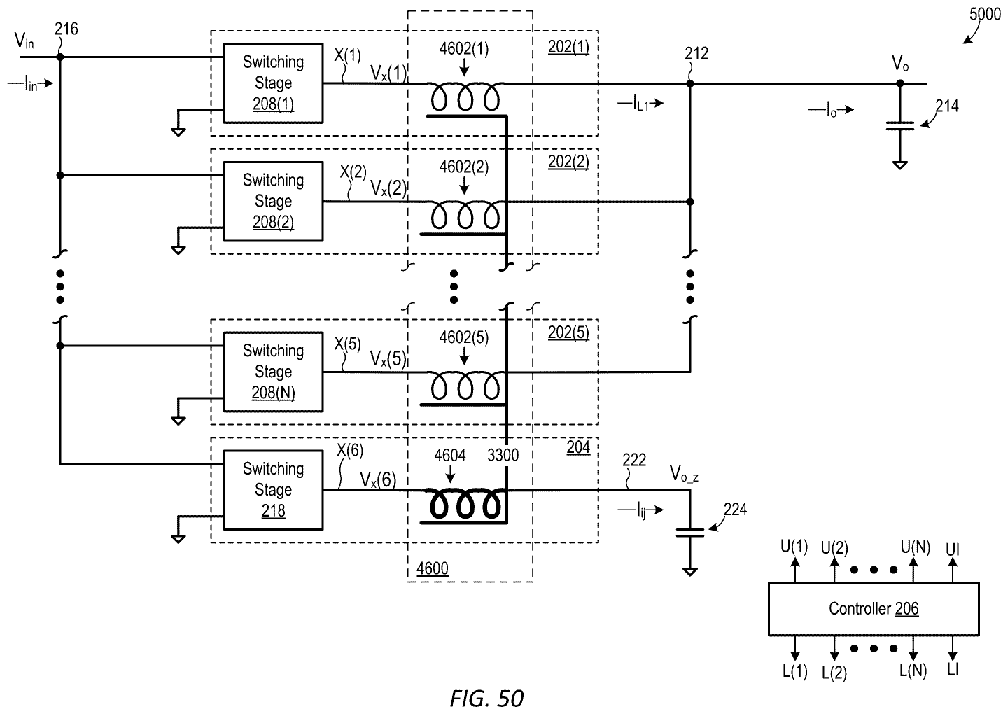

FIG. 50 is a schematic diagram of a multi-phase switching power converter 5000, which is an embodiment of switching power converter 200 (FIG. 2) where (i) N is equal to five and (ii) coupled inductor 228 is embodied by coupled inductor 4600 (FIGS. 46-48). As illustrated in FIG. 40, power transfer windings 210(1) through 210(5) are embodied by power transfer windings 4602(1) though 4602(5), respectively. Additionally, injection winding 220 is embodied by injection winding 4604. Furthermore, magnetic core 226 is embodied by magnetic core 3300. Switching power converter 5000 operates in the same manner as switching power converter 200. For example, controller 206 generates control signals U and L to control duty cycle of power stages 202 to regulate at least one parameter of switching power converter 5000. As another example, controller 206 generates control signals UI and LI to control injection stage 204 such that the injection stage injects magnetic flux in magnetic core 3300 in a manner which reduces voltage across a respective leakage inductance of each power transfer winding 4602.

Referring again to FIG. 46, coupled inductor 4600 may be modified as long as it includes a respective power transfer winding wound around each power transfer rung 3306 and an injection winding wound around all power transfer rungs 3306. For example, in some alternate embodiments, injection rungs 3308 are replaced with a leakage plate disposed over power transfer rungs 3306 in third direction 3314, where the leakage plate provides a path for leakage magnetic flux between first rail 3302 and second rail 3304. As another example, the configuration of solder tabs 4606 and 4608 of injection winding 4604 could be modified. As an additional example, solder tabs 4606 and 4608 could be omitted or replaced with through-hole pins. As a further example, while injection winding 4604 is depicted as being a metallic foil winding having a rectangular cross-section, injection winding 4604 could be replaced with another type of winding, such as a wire winding. Moreover, it is understood that quantity of power transfer windings 4602 and corresponding power transfer rungs 3306 may vary in coupled inductor 4600 without departing from the scope hereof.

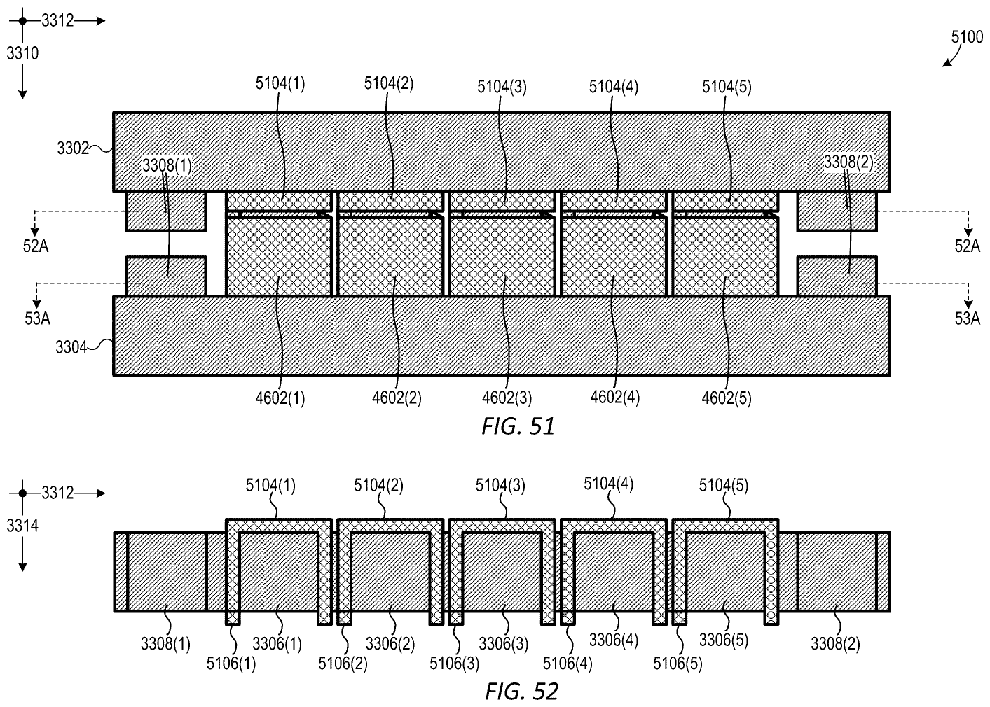

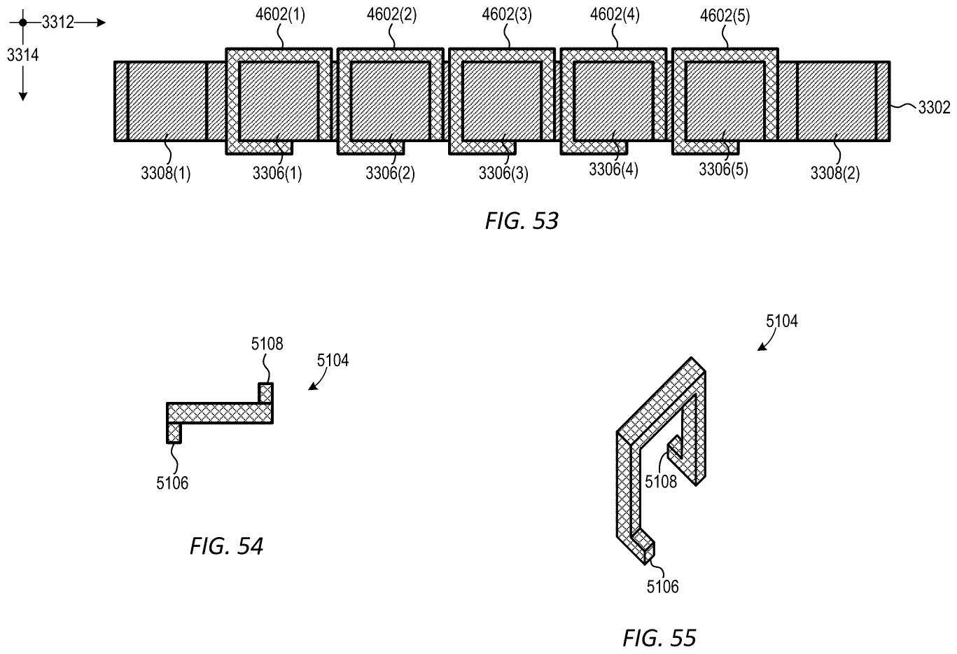

Furthermore, injection winding 4604 could be replaced with a respective injection winding wound around each power transfer rung 3306, where the injection windings are electrically coupled in series. For example, FIG. 51 is a top plan view of a coupled inductor 5100, which is an alternate embodiment of coupled inductor 4600 (FIGS. 46-48) including a plurality of injection windings 5104 in place of injection winding 4604. FIG. 52 is a cross-sectional view of coupled inductor 5100 taken along line 52A-52A of FIG. 51, and FIG. 53 is a cross-sectional view of coupled inductor 5100 taken along line 53A-53A of FIG. 51. FIG. 54 is a top plan view of an injection winding 5104 instance, and FIG. 55 is a cross-sectional view of an injection winding 5104 instance. Each injection winding 5104 forms respective solder tabs 5106 and 5108 at opposing ends of the winding. Each injection winding 5104 is wound around a respective power transfer rung 3306, such that coupled inductor 5100 includes a respective injection winding 5104 for each power transfer winding 4602.

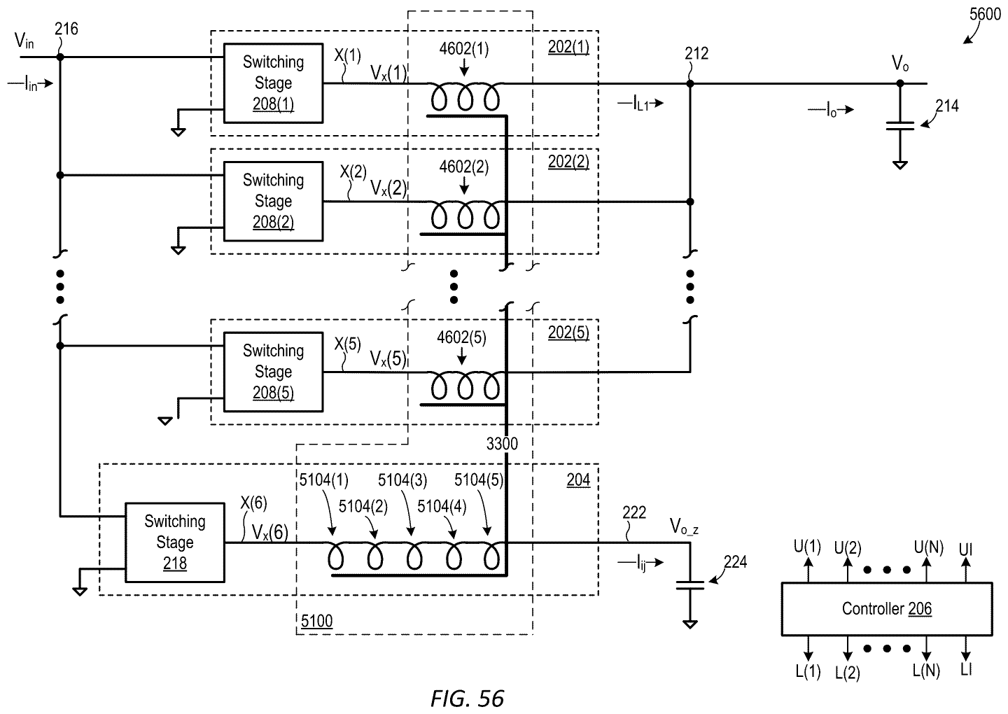

Injection windings 5104 are electrically equivalent to injection winding 4604 of coupled inductor 4600 when injection windings 5104 are electrically coupled in series. Accordingly, all injection windings 5104 are electrically coupled in series when coupled inductor 5100 is used in the above-discussed switching power converters including injection stages, which achieves a 1:1 turns ratio between power transfer windings 4602 and injection windings 5104. For example, FIG. 56 is a schematic diagram of a multi-phase switching power converter 5600, which is an embodiment of switching power converter 200 (FIG. 2) where (i) N is equal to five and (ii) coupled inductor 228 is embodied by coupled inductor 5100 (FIGS. 51-53). As illustrated in FIG. 56, power transfer windings 210(1) through 210(5) are embodied by power transfer windings 4602(1) though 4602(5), respectively. Additionally, injection winding 220 is embodied by the combination of injection windings 5104(1) through 5104(5) electrically coupled in series between switching node X(6) and injection output node 222. Accordingly, injection windings 5104 are driven high when switching node X(6) is at voltage Vᵢₙ, and injection windings 5104 are driven low when switching node X(6) is at zero volts relative to ground. Furthermore, magnetic core 226 is embodied by magnetic core 3300. Switching power converter 5600 operates in the same manner as switching power converter 200. For example, controller 206 generates control signals U and L to control duty cycle of power stages 202 to regulate at least one parameter of switching power converter 5600. As another example, controller 206 generates control signals UI and LI to control injection stage 204 such that the injection stage injects magnetic flux in magnetic core 3300 in a manner which reduces voltage across a respective leakage inductance of each power transfer winding 4602.

Referring again to FIG. 51, coupled inductor 5100 may be modified as long as it includes a respective power transfer winding and a respective injection winding wound around each power transfer rung 3306. For example, in some alternate embodiments, injection rungs 3308 are replaced with a leakage plate disposed over power transfer rungs 3306 in third direction 3314, where the leakage plate provides a path for leakage magnetic flux between first rail 3302 and second rail 3304. As another example, the configuration of solder tabs 5106 and 5108 of each injection winding 5104 could be modified. As an additional example, solder tabs 5106 and 5108 could be omitted from injection windings 5104, or solder tabs 5106 and 5108 could be replaced with through-hole pins. As a further example, while injection windings 5104 are depicted as being metallic foil windings having a rectangular cross-section, injection windings 5104 could be replaced with another type of winding, such as wire windings. Moreover, it is understood that quantity of power transfer windings 4602 and corresponding injection windings 5104 and power transfer rungs 3306 may vary in coupled inductor 5100 without departing from the scope hereof.

### Switching Power Converters Including Injection Stages and Multiple Coupled Inductors

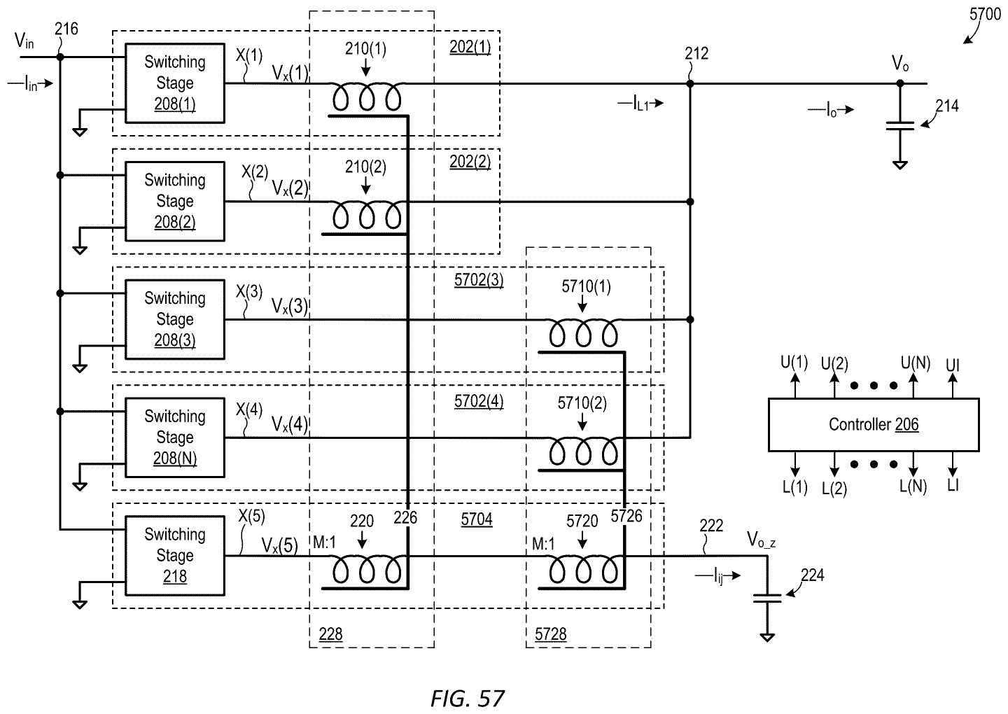

The switching power converters including injection stages discussed above could be modified to include two or more coupled inductors, where (i) the power transfer windings are split between the two or more coupled inductors (ii) and the injection windings of the two or more couple inductors are electrically coupled in series. For example, FIG. 57 is a schematic diagram of a multi-phase switching power converter 5700, which is an alternate embodiment of switching power converter 200 (FIG. 2) including a second coupled inductor 5728 in addition to coupled inductor 228. N is equal to four in switching power converter 200, and power stages 202(1) and 202(2) are configured in switching power converter 5700 in the same manner as in switching power converter 200. However, switching power converter 5700 additionally includes two instances of a power stage 5702, and switching power converter 5700 includes an injection stage 5704 in place injection stage 204. Power stages 5702 are like power stages 202 except that power stages 5702 include respective power transfer windings 5710 in place of power transfer windings 210, where power transfer windings 5710 are part of coupled inductor 5728. Accordingly, power transfer windings of switching power converter 5700 are split between coupled inductor 228 and coupled inductor 5728, i.e., power transfer windings 210(1) and 210(2) are part of coupled inductor 228, and power transfer windings 5710 are part of coupled inductor 5728.

Injection stage 5704 differs from injection stage 204 in that injection stage 5704 further includes an injection winding 5720 of coupled inductor 5728. Coupled inductor 5728 further includes a magnetic core 5726 which magnetically couples each power transfer winding 5710 to each other power transfer winding 5710. Magnetic core 5726 also magnetically couples injection winding 5720 to each power transfer winding 5710. In some embodiments, coupled inductor 5728 is configured similarly to one of the coupled inductors discussed above, e.g., coupled inductor 3100, 3800, 4600, or 5100. Accordingly, in some embodiments, injection winding 5720 is embodied by a plurality of injection windings electrically coupled in series, such as when coupled inductor 5728 is configured similarly to coupled inductor 3800 or 5100. Injection windings 220 and 5720 are electrically coupled in series between switching node X(5) and injection output node 222. Accordingly, injection windings 220 and 5720 are driven high when switching node X(5) is at voltage Vᵢₙ, and injection windings 220 and 5720 are driven low when switching node X(5) is at zero volts relative to ground.

Switching power converter 5700 operates in the same manner as switching power converter 200. For example, controller 206 generates control signals U and L to control duty cycle of power stages 202 and 5702 to regulate at least one parameter of switching power converter 5700. As another example, controller 206 generates control signals UI and LI to control injection stage 5704 such that the injection stage injects magnetic flux in magnetic cores 226 and 5726 in a manner which reduces voltage across a respective leakage inductance of each power transfer winding 210 and 5710. For instance, controller 206 may control switching stage 218 to cause injection windings 220 and 5720 to be driven high in response to a power transfer winding 210 or 5710 being driven low, such as in a manner analogous to that illustrated in FIGS. 5A-5D or 6A-6F.

Voltage between switching node X(5) and injection output node 222 is divided among each injection winding 220 and 5720 when the injection windings are driven high. Consequently, each injection winding of injection stage 5704 forms M times the number of turns as each power transfer winding of power stages 202 and 5702, to compensate for the division of voltage between injection windings, where M is the quantity of injection windings in injection stage 5704. For example, assume that each power transfer winding 210 and 5710 forms one turn. Each injection winding 220 and 5720 would therefore form two turns in view of M being equal to two in switching power converter 5700.

Modifications to switching power converter 5700 are possible. For example, switching power converter 5700 could be modified to include a different quantity of power stages 202 and/or 5702, such as to increase or decrease the quantity of phase of switching power converter 5700 and/or to modify the split of power transfer windings between coupled inductors 228 and 5728. For instance, in one alternate embodiment of switching power converter 5700, the switching power converter is a two-phase switching power converter including only one instance of switching stage 202 and only one instance of power stage 5702, such that each coupled inductor 228 and 5728 includes only one power transfer winding 210 and 5710, respectively. As another example, switching power converter 5700 could be modified to include one or more additional coupled inductors, such that power transfer windings of switching power converter 5700 are split between three of more coupled inductors, where the injection windings of the three or more coupled inductor are electrically coupled in series between switching node X(5) and injection output node 222. As a further example, injection stage 5704 could be modified to compensate for a power transfer winding 210 or 5710 being driven high, such as an in a manner analogous to switching power converter 700 (FIG. 7), where controller 206 is configured to control switching stage 218 to cause injection windings 220 and 5720 to be driven high in response to a power transfer winding 210 or 5710 being driven high, such as in a manner analogous to that illustrated in FIGS. 8A-8D. Additionally, the other switching power converters discussed above, e.g., switching power converters 700, 900, 1100, 1300, and 1500, could be modified to include two or more coupled inductors in a manner analogous to switching power converter 5700.

### Combinations of Features

Features described above may be combined in various ways without departing from the scope hereof. The following examples illustrate some possible combinations.
(A1) A method for operating a switching power converter to reduce ripple current magnitude includes (1) controlling duty cycle of a plurality power stages of the switching power converter to regulate at least one parameter of the switching power converter, each power stage including a respective power transfer winding that is magnetically coupled to the respective power transfer winding of each other power stage, and (2) controlling an injection stage of the switching power converter to reduce voltage across a respective leakage inductance of each power transfer winding, the injection stage including an injection winding that is magnetically coupled to each power transfer winding.
(A2) The method denoted as (A1) may further include causing the plurality of power stages to switch out-of-phase with respect to each other.
(A3) In any one of the methods denoted as (A1) and (A2), controlling the injection stage to reduce voltage across the respective leakage inductance of each power transfer winding may include driving the injection winding high in response to a power transfer winding being driven low.
(A4) In any one of the methods denoted as (A1) and (A2), controlling the injection stage to reduce voltage across the respective leakage inductance of each power transfer winding may include driving the injection winding high in response to one of the power transfer windings being driven low while at least one of the remaining power transfer windings are driven high.
(A5) In any one of the methods denoted as (A1) and (A2), controlling the injection stage to reduce voltage across the respective leakage inductance of each power transfer winding may include causing the injection stage to compensate for one or more of the power transfer windings being driven low.
(A6) In any one of the methods denoted as (A1) and (A2), controlling the injection stage to reduce voltage across the respective leakage inductance of each power transfer winding may include driving the injection winding high in response to one of the power transfer windings being driven high.
(A7) In any one of the methods denoted as (A1) and (A2), controlling the injection stage to reduce voltage across the respective leakage inductance of each power transfer winding may include causing the injection stage to compensate for one or more of the power transfer windings being driven high.
(A8) Any one of the methods denoted as (A1) through (A7) may further include disabling the injection stage in response to a signal indicating that the switching power converter is experiencing a transient event.
(A9) Any one of the methods denoted as (A1) through (A7) may further include controlling the injection stage to change timing of switching of the injection stage in response to a signal indicating that the switching power converter is experiencing a transient event.
(A10) In any one of the methods denoted as (A1) through (A9), the at least one parameter of the switching power converter may include one of magnitude of a voltage and magnitude of a current
(A11) In any one of the methods denoted as (A1) through (A10), the plurality of power transfer windings and the injection winding may be part of a common coupled inductor.
(A12) In the method denoted as (A11), the common coupled inductor may include an asymmetric magnetic core.
(A13) In any one of the methods denoted as (A1) through (A12), the switching power converter may have a topology selected from the group consisting of a multi-phase buck-type topology, a multi-phase boost-type topology, and a multi-phase buck-boost-type topology.
(A14) In any one of the methods denoted as (A1) through (A13), two or more of the plurality of power stages may be part of different respective power sub-converters.
(B1) A method for operating a switching power converter to reduce ripple current magnitude may include (1) controlling duty cycle of a power stage of the switching power converter to regulate at least one parameter of the switching power converter, the power stage including a power transfer winding, and (2) controlling an injection stage of the switching power converter to reduce voltage across a leakage inductance of the power transfer winding, the injection stage including an injection winding that is magnetically coupled to the power transfer winding.
(B2) In the method denoted as (B1), controlling the injection stage to reduce voltage across the leakage inductance of the power transfer winding may include driving the injection winding high in response to the power transfer winding being driven low.
(B3) In the method denoted as (B1), controlling the injection stage to reduce voltage across the leakage inductance of the power transfer winding may include causing the injection stage to compensate for the power transfer winding being driven low.
(B4) In the method denoted as (B1), controlling the injection stage to reduce voltage across the leakage inductance of the power transfer winding may include driving the injection winding high in response to the power transfer winding being driven high.
(B5) In the method denoted as (B1), controlling the injection stage to reduce voltage across the leakage inductance of the power transfer winding may include causing the injection stage to compensate for the power transfer winding being driven high.
(B6) Any one of the methods denoted as (B1) through (B5) may further include disabling the injection stage in response to a signal indicating that the switching power converter is experiencing a transient event.
(B7) Any one of the methods denoted as (B1) through (B5) may further include controlling the injection stage to change timing of switching of the injection stage in response to a signal indicating that the switching power converter is experiencing a transient event.
(B8) In any one of the methods denoted as (B1) through (B7), the at least one parameter of the switching power converter may include one of magnitude of a voltage and magnitude of a current.
(B9) In any one of the methods denoted as (B1) through (B8), the switching power converter may have a topology selected from the group consisting of a buck-type topology, a boost-type topology, and a buck-boost-type topology.
(C1) A switching power converter includes (1) a plurality of power stages, each power stage including a respective power transfer winding that is magnetically coupled to the respective power transfer winding of each other power stage, (2) an injection stage including an injection winding that is magnetically coupled to each power transfer winding, and (3) a controller configured to (a) control duty cycle of the plurality power stages to regulate at least one parameter of the switching power converter and (b) control the injection stage to reduce voltage across a respective leakage inductance of each power transfer winding.
(C2) In the switching power converter denoted as (C1), each power stage may include a respective power switching stage electrically coupled to the power transfer winding of the power stage, each power switching stage being at least partially controlled by the controller, and the injection stage may include an injection switching stage electrically coupled to the injection winding, where the injection switching stage is at least partially controlled by the controller.
(C3) In the switching power converter denoted as (C2), the injection winding may be electrically coupled between the injection switching stage and a capacitor.
(C4) In any one of the switching power converters denoted as (C1) through (C3), the controller may be further configured to cause the plurality of power stages to switch out-of-phase with respect to each other.
(C5) In any one of the switching power converters denoted as (C1) through (C4), the controller may be further configured to control the injection stage to reduce voltage across the respective leakage inductance of each power transfer winding at least partially by causing the injection winding to be driven high in response to a power transfer winding being driven low.
(C6) In any one of the switching power converters denoted as (C1) through (C4), the controller may be further configured to control the injection stage to reduce voltage across the respective leakage inductance of each power transfer winding at least partially by causing the injection winding to be driven high in response to one of the power transfer windings being driven low while at least one of the remaining power transfer windings are driven high.
(C7) In any one of the switching power converters denoted as (C1) through (C4), the controller may be further configured to control the injection stage to reduce voltage across the respective leakage inductance of each power transfer winding at least partially by causing the injection winding to be driven high in response to one of the power transfer windings being driven high.
(C8) In any one of the switching power converters denoted as (C1) through (C7), the controller may be further configured to disable the injection stage in response to a signal indicating that the switching power converter is experiencing a transient event.
(C9) In any one of the switching power converters denoted as (C1) through (C7), the controller may be further configured to cause the injection stage to change timing of switching of the injection stage, in response to a signal indicating that the switching power converter is experiencing a transient event.
(C10) In any one of the switching power converters denoted as (C1) through (C9), the at least one parameter of the switching power converter may include one of magnitude of a voltage and magnitude of a current.
(C11) In any one of the switching power converters denoted as (C1) through (C10), the plurality of power transfer windings and the injection winding may be part of a common coupled inductor.
(C12) In the switching power converter denoted as (C11), the coupled inductor may be asymmetrical.
(C13) In any one of the switching power converters denoted as (C1) through (C12), the injection stage may be powered from a different power node than plurality of power stages.
(C14) In any one of the switching power converters denoted as (C1) through (C13), the switching power converter may have a topology selected from the group consisting of a multi-phase buck-type topology, a multi-phase boost-type topology, and a multi-phase buck-boost-type topology.
(C15) In any one of the switching power converters denoted as (C1) through (C14), two or more of the plurality of power stages may be part of different respective power sub-converters.
(D1) A switching power converter includes (1) a plurality of power stages, each power stage including a respective power transfer winding, (2) an injection stage including a plurality of injection windings, the injection windings being electrically coupled in series, (3) a magnetic core, and (4) a controller. The magnetic core includes (1) a first rail and a second rail separated from each other in a first direction, (2) a plurality of power transfer rungs disposed between the first rail and the second rail in the first direction, and (3) a plurality of injection rungs disposed between the first rail and the second rail in the first direction. Each power transfer rung is separated from each other power transfer rung in a second direction that is orthogonal to the first direction, and each power transfer winding is wound around a respective one of the plurality of power transfer rungs. Each injection rung is separated from each other injection rung in the second direction, and each injection winding is wound around a respective one of the plurality of injection rungs. The controller is configured to (1) control duty cycle of the power stages to regulate at least one parameter of the switching power converter and (2) control the injection stage to reduce voltage across a respective leakage inductance of each power transfer winding.
(D2) In the switching power converter denoted as (D1), each power transfer winding and each injection winding may have a common configuration.
(D3) In either one of the switching power converters denoted as (D1) and (D2), (1) each power transfer rung may form a respective gap having a first thickness in the first direction, (2) each injection rung may form a respective gap having a second thickness in the first direction, and (3) the second thickness may be different from the first thickness.
(D4) In any one of the switching power converters denoted as (D1) through (D3), the second thickness may be greater than the first thickness.
(D5) In any one of the switching power converters denoted as (D1) through (D4), each power transfer rung may be separated from each injection rung in the second direction.
(D6) In any one of the switching power converters denoted as (D1) through (D5), the first rail, the second rail, the power transfer rungs, and the injection rungs may be formed of one of a ferrite magnetic material and an iron powder iron magnetic material.
(D7) In any one of the switching power converters denoted as (D1) through (D6), the power transfer windings, the injection windings, and the magnetic core may be part of a common coupled inductor.
(D8) In any one of the switching power converters denoted as (D1) through (D7), the controller may be further configured to control the injection stage to reduce voltage across the respective leakage inductance of each power transfer winding at least partially by causing the injection windings to be driven high in response to a power transfer winding being driven low.
(D9) In any one of the switching power converters denoted as (D1) through (D7), the controller may be further configured to control the injection stage to reduce voltage across the respective leakage inductance of each power transfer winding at least partially by causing the injection windings to be driven high in response to one of the power transfer windings being driven low while at least one other of the power transfer windings is being driven high.
(D10) In any one of the switching power converters denoted as (D1) through (D7), the controller may be further configured to control the injection stage to reduce voltage across the respective leakage inductance of each power transfer winding at least partially by causing the injection windings to be driven high in response to one of the power transfer windings being driven high.
(E1) A switching power converter includes (1) a plurality of power stages, each power stage including a respective power transfer winding, (2) an injection stage including an injection winding, the injection winding and each power transfer winding having a common configuration, (3) a magnetic core, and (4) a controller. The magnetic core includes (1) a first rail and a second rail separated from each other in a first direction, (2) a plurality of power transfer rungs disposed between the first rail and the second rail in the first direction, and (3) an injection rung disposed between the first rail and the second rail in the first direction. Each power transfer rung is separated from each other power transfer rung in a second direction that is orthogonal to the first direction, and each power transfer winding is wound around a respective one of the plurality of power transfer rungs. The injection winding is wound around the injection rung. The controller configured to (1) control duty cycle of the power stages to regulate at least one parameter of the switching power converter and (2) control the injection stage to reduce voltage across a respective leakage inductance of each power transfer winding.
(E2) In the switching power converter denoted as (E1), (1) each power transfer rung may form a respective gap having a first thickness in the first direction, (2) the injection rung may form a gap having a second thickness in the first direction, and (3) the second thickness may be different from the first thickness.
(E3) In the switching power converter denoted as (E2), the second thickness may be greater than the first thickness.
(E4) In any one of the switching power converters denoted as (E1) through (E3), each power transfer rung may be separated from the injection rung in the second direction.
(E5) In any one of the switching power converters denoted as (E1) through (E4), the first rail, the second rail, the power transfer rungs, and the injection rung may be formed of one of a ferrite magnetic material and an iron powder iron magnetic material.
(E6) In any one of the switching power converters denoted as (E1) through (E5), the power transfer windings, the injection winding, and the magnetic core may be part of a common coupled inductor.
(E7) In any one of the switching power converters denoted as (E1) through (E6), the controller may be further configured to control the injection stage to reduce voltage across the respective leakage inductance of each power transfer winding at least partially by causing the injection winding to be driven high in response to a power transfer winding being driven low.
(E8) In any one of the switching power converters denoted as (E1) through (E6), the controller may be further configured to control the injection stage to reduce voltage across the respective leakage inductance of each power transfer winding at least partially by causing the injection winding to be driven high in response to one of the power transfer windings being driven low while at least one other of the power transfer windings is driven high.
(E9) In any one of the switching power converters denoted as (E1) through (E6), the controller may be further configured to control the injection stage to reduce voltage across the respective leakage inductance of each power transfer winding at least partially by causing the injection winding to be driven high in response to one of the power transfer windings being driven high.
(E10) In any one of the switching power converters denoted as (E1) through (E9), (1) the plurality of power stages may include a first power stage and a second power stage, (2) a respective power transfer winding of the first power stage may be wound around a first power transfer rung of the plurality of power transfer rungs, (3) a respective power transfer winding of the second power stage may be wound around a second power transfer rung of the plurality of power transfer rungs, and (4) the injection rung may be disposed between the first power transfer rung and the second power transfer rung in the second direction.
(F1) A switching power converter includes (1) a plurality of power stages, each power stage including a respective power transfer winding, (2) an injection stage including an injection winding, (3) a magnetic core, and (4) a controller. The magnetic core includes a first rail and a second rail separated from each other in a first direction and a plurality of power transfer rungs disposed between the first rail and the second rail in the first direction. Each power transfer rung is separated from each other power transfer rung in a second direction that is orthogonal to the first direction, and each power transfer winding is wound around a respective one of the plurality of power transfer rungs. The injection winding is wound around all of the plurality of power transfer rungs. The controller configured to (i) control duty cycle of the power stages to regulate at least one parameter of the switching power converter and (ii) control the injection stage to reduce voltage across a respective leakage inductance of each power transfer winding.
(F2) In the switching power converter denoted as (F1), the controller may be further configured to control the injection stage to reduce voltage across the respective leakage inductance of each power transfer winding at least partially by causing the injection winding to be driven high in response to a power transfer winding being driven low.
(F3) In the switching power converter denoted as (F1), the controller may be further configured to control the injection stage to reduce voltage across the respective leakage inductance of each power transfer winding at least partially by causing the injection winding to be driven high in response to one of the power transfer windings being driven high.
(F4) In the switching power converter denoted as (F1), the controller may be further configured to control the injection stage to reduce voltage across the respective leakage inductance of each power transfer winding at least partially by causing the injection winding to be driven high in response to one of the power transfer windings being driven low while at least one other of the power transfer windings is driven high.
(F5) In any one of the switching power converters denoted as (F1) through (F4), the first rail, the second rail, and the power transfer rungs may be formed of one of a ferrite magnetic material and an iron powder iron magnetic material.
(F6) In any one of the switching power converters denoted as (F1) through (F5), the power transfer windings, the injection winding, and the magnetic core may be part of a common coupled inductor.
(G1) A switching power converter includes (1) a plurality of power stages, each power stage including a respective power transfer winding, (2) an injection stage including a plurality of injection windings, the injection windings being electrically coupled in series, (3) a magnetic core, and (4) a controller. The magnetic core includes (1) a first rail and a second rail separated from each other in a first direction and (2) a plurality of power transfer rungs disposed between the first rail and the second rail in the first direction. Each power transfer rung is separated from each other power transfer rung in a second direction that is orthogonal to the first direction, and each power transfer winding is wound around a respective one of the plurality of power transfer rungs. Additionally, each injection winding is wound around a respective one of the plurality of power transfer rungs. The controller is configured to (1) control duty cycle of the power stages to regulate at least one parameter of the switching power converter and (2) control the injection stage to reduce voltage across a respective leakage inductance of each power transfer winding
(G2) In the switching power converter denoted as (G1), the controller may be further configured to control the injection stage to reduce voltage across the respective leakage inductance of each power transfer winding at least partially by causing the injection windings to be driven high in response to a power transfer winding being driven low.
(G3) In the switching power converter denoted as (G1), the controller may be further configured to control the injection stage to reduce voltage across the respective leakage inductance of each power transfer winding at least partially by causing the injection windings to be driven high in response to one of the power transfer windings being driven high.
(G4) In the switching power converter denoted as (G1), the controller may be further configured to control the injection stage to reduce voltage across the respective leakage inductance of each power transfer winding at least partially by causing the injection windings to be driven high in response to one of the power transfer windings being driven low while at least one other of the power transfer windings is driven high.
(G5) In any one of the switching power converters denoted as (G1) through (G4), the first rail, the second rail, and the power transfer rungs may be formed of one of a ferrite magnetic material and an iron powder iron magnetic material.
(G6) In any one of the switching power converters denoted as (G1) through (G5), the power transfer windings, the injection winding, and the magnetic core may be part of a common coupled inductor.
(H1) A switching power converter includes (1) a plurality of first power stages, each first power stage including a respective first power transfer winding that is magnetically coupled to the respective first power transfer winding of each other first power stage, (2) a plurality of second power stages, each second power stage including a respective second power transfer winding that is magnetically coupled to the respective second power transfer winding of each other second power stage, (3) an injection stage including (i) a first injection winding that is magnetically coupled to each first power transfer winding and (ii) a second injection winding that magnetically coupled to each second power transfer winding, the first and second injection winding being electrically coupled in series, and (4) a controller configured to (a) control duty cycle of the plurality of first power stages and the plurality of second power stages to regulate at least one parameter of the switching power converter and (b) control the injection stage to reduce voltage across a respective leakage inductance of each first power transfer winding and each second power transfer winding.
(H2) In the switching power converter denoted as (H1), the controller may be further configured to cause the plurality of first power stages and the plurality of second power stages to switch out-of-phase with respect to each other.
(H3) In either one of the switching power converters denoted as (H1) and (H2), the controller may be further configured to control the injection stage to reduce voltage across the respective leakage inductance of each first power transfer winding and each second power transfer winding at least partially by causing the first and second injection windings to be driven high in response to either (i) one of the first power transfer windings being driven low or (ii) one of the second power transfer windings being driven low.
(H4) In either one of the switching power converters denoted as (H1) and (H2), the controller may be further configured to control the injection stage to reduce voltage across the respective leakage inductance of each first power transfer winding and each second power transfer winding at least partially by causing the first and second injection windings to be driven high in response to one of (i) one of the first power transfer windings being driven high or (ii) one of the second power transfer windings being driven high.
(H5) In any one of the switching power converters denoted as (H1) through (H4), (1) the first power transfer windings and the first injection winding may be part of a first coupled inductor, and (2) the second power transfer windings and the second injection winding may be part of a second coupled inductor.
(I1) A switching power converter includes (1) a first power stage including a first power transfer winding, (2) a second power stage including a second power transfer winding, (3) an injection stage including (i) a first injection winding that is magnetically coupled to the first power transfer winding and (ii) a second injection winding that magnetically coupled to the second power transfer winding, the first and second injection windings being electrically coupled in series, and (4) a controller configured to (a) control duty cycle of the first and second power stages to regulate at least one parameter of the switching power converter and (b) control the injection stage to reduce voltage across a respective leakage inductance of each of the first and second power transfer windings.
(I2) In the switching power converter denoted as (I1), the controller may be further configured to cause the first power stage and the second power stage to switch out-of-phase with respect to each other.
(I3) In either one of the switching power converters denoted as (I1) and (I2), (1) the first power transfer winding and the first injection winding may be part of a first coupled inductor, and (2) the second power transfer winding and the second injection winding may be part of a second coupled inductor.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A switching power converter, comprising:
a plurality of power stages, each power stage including a respective power transfer winding;
an injection stage including a plurality of injection windings, the injection windings being electrically coupled in series;
a magnetic core, including:
a first rail and a second rail separated from each other in a first direction,
a plurality of power transfer rungs disposed between the first rail and the second rail in the first direction, each power transfer rung being separated from each other power transfer rung in a second direction that is orthogonal to the first direction, each power transfer winding being wound around a respective one of the plurality of power transfer rungs, and
a plurality of injection rungs disposed between the first rail and the second rail in the first direction, each injection rung being separated from each other injection rung in the second direction, each injection winding being wound around a respective one of the plurality of injection rungs; and
a controller configured to:
control duty cycle of the power stages to regulate at least one parameter of the switching power converter, and
control the injection stage to reduce voltage across a respective leakage inductance of each power transfer winding.

2. The switching power converter of claim 1, wherein each power transfer winding and each injection winding has a common configuration.

3. The switching power converter of claim 1, wherein:
each power transfer rung forms a respective gap having a first thickness in the first direction;
each injection rung forms a respective gap having a second thickness in the first direction; and
the second thickness is different from the first thickness.

4. The switching power converter of claim 1, wherein each power transfer rung is separated from each injection rung in the second direction.

5. The switching power converter of claim 1, wherein the power transfer windings, the injection windings, and the magnetic core are part of a common coupled inductor.

6. The switching power converter of claim 1, wherein the controller is further configured to control the injection stage to reduce voltage across the respective leakage inductance of each power transfer winding at least partially by causing the injection windings to be driven high in response to a power transfer winding being driven low.

7. The switching power converter of claim 1, wherein the controller is further configured to control the injection stage to reduce voltage across the respective leakage inductance of each power transfer winding at least partially by causing the injection windings to be driven high in response to one of the power transfer windings being driven low while at least one other of the power transfer windings is being driven high.

8. The switching power converter of claim 1, wherein the controller is further configured to control the injection stage to reduce voltage across the respective leakage inductance of each power transfer winding at least partially by causing the injection windings to be driven high in response to one of the power transfer windings being driven high.

9. A switching power converter, comprising:
a plurality of power stages, each power stage including a respective power transfer winding;
an injection stage including an injection winding, the injection winding and each power transfer winding having a common configuration;
a magnetic core, including:
a first rail and a second rail separated from each other in a first direction,
a plurality of power transfer rungs disposed between the first rail and the second rail in the first direction, each power transfer rung being separated from each other power transfer rung in a second direction that is orthogonal to the first direction, each power transfer winding being wound around a respective one of the plurality of power transfer rungs, and
an injection rung disposed between the first rail and the second rail in the first direction, the injection winding being wound around the injection rung; and
a controller configured to:
control duty cycle of the power stages to regulate at least one parameter of the switching power converter, and
control the injection stage to reduce voltage across a respective leakage inductance of each power transfer winding.

10. The switching power converter of claim 9, wherein:
each power transfer rung forms a respective gap having a first thickness in the first direction;
the injection rung forms a gap having a second thickness in the first direction; and
the second thickness is different from the first thickness.

11. The switching power converter of claim 9, wherein each power transfer rung is separated from the injection rung in the second direction.

12. The switching power converter of claim 9, wherein the first rail, the second rail, the power transfer rungs, and the injection rung are formed of one of a ferrite magnetic material and an iron powder iron magnetic material.

13. The switching power converter of claim 9, wherein the power transfer windings, the injection winding, and the magnetic core are part of a common coupled inductor.

14. The switching power converter of claim 9, wherein the controller is further configured to control the injection stage to reduce voltage across the respective leakage inductance of each power transfer winding at least partially by causing the injection winding to be driven high in response to a power transfer winding being driven low.

15. The switching power converter of claim 9, wherein the controller is further configured to control the injection stage to reduce voltage across the respective leakage inductance of each power transfer winding at least partially by causing the injection winding to be driven high in response to one of the power transfer windings being driven low while at least one other of the power transfer windings is driven high.

16. The switching power converter of claim 9, wherein the controller is further configured to control the injection stage to reduce voltage across the respective leakage inductance of each power transfer winding at least partially by causing the injection winding to be driven high in response to one of the power transfer windings being driven high.

17. The switching power converter of claim 11, wherein:
the plurality of power stages comprises a first power stage and a second power stage;
a respective power transfer winding of the first power stage is wound around a first power transfer rung of the plurality of power transfer rungs;
a respective power transfer winding of the second power stage is wound around a second power transfer rung of the plurality of power transfer rungs; and
the injection rung is disposed between the first power transfer rung and the second power transfer rung in the second direction.

18. A switching power converter, comprising:
a plurality of power stages, each power stage including a respective power transfer winding;
an injection stage including an injection winding;
a magnetic core, including:
a first rail and a second rail separated from each other in a first direction, a plurality of power transfer rungs disposed between the first rail and the second rail in the first direction, each power transfer rung being separated from each other power transfer rung in a second direction that is orthogonal to the first direction, each power transfer winding being wound around a respective one of the plurality of power transfer rungs, and the injection winding being wound around all of the plurality of power transfer rungs; and
a controller configured to:
control duty cycle of the power stages to regulate at least one parameter of the switching power converter, and
control the injection stage to reduce voltage across a respective leakage inductance of each power transfer winding.

19. The switching power converter of claim 18, wherein the controller is further configured to control the injection stage to reduce voltage across the respective leakage inductance of each power transfer winding at least partially by causing the injection winding to be driven high in response to a power transfer winding being driven low.

20. The switching power converter of claim 18, wherein the controller is further configured to control the injection stage to reduce voltage across the respective leakage inductance of each power transfer winding at least partially by causing the injection winding to be driven high in response to one of the power transfer windings being driven high.
